(19) United States
(12) Patent Application Publication
(10) Pub. No.: US 2026/0073528 A1
(43) Pub. Date: Mar. 12, 2026

(54) OBJECT TRACKING BASED ON CLUSTERING OF TRACKLETS

(71) Applicant: QUALCOMM Incorporated, San Diego, CA (US)

(72) Inventors: Varun RAVI KUMAR, San Diego, CA (US); Kiran BANGALORE RAVI, Paris (FR); Senthil Kumar YOGAMANI, San Diego, CA (US)

(21) Appl. No.: 18/830,399

(22) Filed: Sep. 10, 2024

(51) Int. Cl. G06T 7/20; G06T 7/70; G06V 10/762

(52) U.S. Cl. CPC G06T 7/20; G06T 7/70; G06V 10/762; G06T 2207/30241; G06V 2201/07

(57) ABSTRACT

Certain aspects of the present disclosure provide techniques for object tracking. A method generally includes detecting object(s) in a set of frames associated with a first period of time; generating first tracklets, wherein each respective first tracklet comprises a respective sequence of states associated with a respective object over the first period of time, and represents a respective first trajectory for the respective object over the first period of time; clustering two or more first tracklets into first clustered tracklet(s); and determining a second trajectory for a set of the object(s) over a second period of time based on one of the first clustered tracklets.

### INTRODUCTION

### Field of the Disclosure

Aspects of the present disclosure relate to object tracking.

### DESCRIPTION OF RELATED ART

Object tracking is an important computer vision task that aims to estimate the trajectory(ies) of one or more objects of interest (e.g., cars, pedestrians, bicycles, etc.) across successive frames. The objective of object tracking is to maintain a consistent association between an object and its representation across different frames, despite changes in position, scale, orientation, and/or appearance, including when the object temporarily disappears from view and/or becomes obscured. Object tracking may include two-dimensional and three-dimensional (3D) object tracking. While 2D object tracking operates to track object(s) based on individual image frames, 3D object tracking is based on identifying and monitoring object(s) in a 3D environment based on spatial and temporal information present in 3D data representations (e.g., such as point cloud sequences). Object tracking, including 2D and/or 3D object tracking, is fundamental in various applications, including autonomous driving, robot navigation, augmented reality, security and surveillance, and human computer interaction, to name a few.

One approach to 3D object tracking includes using a tracking-by-detection method in combination with a tracking filter (referred to as “single-frame recursive filtering” and/or a “sliding window approach”). The tracking-by-detection method may include two steps: (1) a detection step and (2) an association step. During the detection step, one or more detections may be made within a given frame or observation window, where a “detection” refers to the identification and localization of an object or object state (e.g., velocity, size, orientation, heading, semantic class, etc.). This identification may be represented by various data types, such as bounding boxe(es), point(s), cluster(s), and/or the like (e.g., such as depending on sensor modality and the specific application for the object tracking). The association step may include assigning each detection to an existing trajectory (also referred to herein as a “tracklet,” which may refer to a temporal sequence of detections associated with a single object over multiple frames). Put differently, the tracking-by-detection method tackles data association by linking current detection(s) (e.g., associated with the given frame or observation window) with previously-created tracklet(s).

An association between a current detection and a previously-created tracklet may include updating a tracking filter associated with the tracklet. Specifically, a tracking filter is an algorithm used to estimate and predict the future states of objects in motion. A tracking filer may estimate and predict the future states based on smoothing out noisy observations and/or maintaining consistent tracking, even through occlusions. For an existing tracklet, newly-associated detections may be used by the tracking filter to update the state of an object associated with the existing tracklet. The tracking filter may use this updated state to predict (e.g., estimate) a future state of the object (e.g., predicting the position and other relevant information about the object) for object tracking. Put differently, the tracking filter may use the updated state to improve its prediction about a future state of the object assuming the model holds true. Example tracking filters may include various types of Kalman filters, such as a linear Kalman filter or an extended Kalman filter, and/or non-Gaussian filters, such as a Gaussian-sum filter or a particle filter, although other tracking filters may be considered.

### SUMMARY

One aspect provides a method for object tracking. The method generally includes detecting one or more objects in a first set of frames associated with a first period of time; generating a plurality of first tracklets, wherein each respective first tracklet of the plurality of first tracklets comprises a respective sequence of states associated with a respective object of the one or more objects over the first period of time, the respective sequence of states representing a respective first trajectory for the respective object over the first period of time; clustering two or more first tracklets of the plurality of first tracklets into one or more first clustered tracklets; and one or more similarity criteria; and determining a second trajectory for a set of the one or more objects over a second period of time based on a first clustered tracklet of the one or more first clustered tracklets.

One aspect provides a method for object tracking. The method generally includes determining a respective plurality of states for one or more objects in a first set of frames associated with a first temporal resolution; generating a plurality of association graphs, wherein: each association graph represents a respective trajectory of, at least one of, a first object of the one or more objects or a first subset of objects of the one or more objects; and each association graph is associated with a different temporal resolution based on adjusting the respective plurality of states for the one or more objects; and tracking the one or more objects using the plurality of association graphs.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example workflow for object tracking based on clustering of tracklets.

FIGS. 2A-2B depict an example graph construction for tracklets and clustered tracklet generation.

FIG. 3 depicts example clustered tracklets generated for a group of objects and a long object.

FIG. 4A depicts an example method for object tracking.

FIG. 4B depicts another example method for object tracking.

FIG. 5 depicts aspects of an example device configured to perform object tracking.

### DETAILED DESCRIPTION

Aspects of the present disclosure provide apparatuses, methods, processing systems, and computer-readable mediums for object tracking based on clustering of tracklets. In certain aspects, techniques for object tracking based on clustering of tracklets, as discussed herein, may be used to robustly track objects in real-world scenarios with dynamic scenes, including long objects and/or groups of objects.

As used herein, a long object may refer to an object characterized by its elongated shape and large spatial extent. A long object may be associated with two or more tracklets due to its susceptibility to occlusions when performing object tracking, which often results in the generation of unassociated tracklets for the object (this concept is described in more detail below). For example, a truck with a trailer may represent a single object in a scene captured by a sequence of frames over a period of time; however, a first tracklet representing a trajectory of the truck over the period of time may be created separately from a second tracklet representing a trajectory of the trailer over the period of time, although the truck and the trailer represent a single object and are moving together in the scene.

Further, as used herein, a group of objects may refer to multiple objects moving in a coordinated manner over a period of time. Put differently, a same pattern of motion may exist for each object included in the group of objects. Example groups of objects may include a group of bikers or runners with similar speed and appearance, flocks of birds migrating south for the winter, multiple vehicles in a traffic jam, and/or other clusters of objects with long temporal presence. In certain aspects, a group of objects may appear as closely packed detections (e.g., associated with multiple objects) captured in a sequence of frames. In certain aspects, a group of objects may exhibit erratic movement patterns.

Although object tracking has been studied for several decades, and much progress has been made in recent years, object tracking remains a technically challenging task. Numerous factors may contribute to the increased difficulty of object tracking, including occlusions, densely populated scenes, and real-time processing requirements, to name a few.

For example, some object tracking systems may struggle when object(s) become occluded in a frame (e.g., of a sequence of frames). Occlusions can occur in various forms, such as partial occlusions where only a portion of an object is blocked from view, or full occlusion where an entire object is hidden for a period of time (e.g., for one or more frames of the sequence of frames). Occlusions often disrupt the continuity of an object's tracklet, leading to identity switches or track interruptions. For example, when an object is occluded, a tracking system may lose track of the object's identity and thus, assign the object a new identifier for tracking when it reappears. This may lead to fragmented tracklets being associated with the same object. In some applications, such as autonomous driving and/or video surveillance, maintaining accurate and consistent object identities may be important for decision making and/or scene understanding. Fragmented tracklets caused by occlusions may lead to incorrect analysis and, in some cases, potentially dangerous situations. Moreover, the advent of 3D object detection and tracking techniques has introduced additional challenges in handling occlusions. Unlike 2D object detection, which operates on individual image frames, 3D object detection may consider the spatial and temporal information present in point cloud sequences or other 3D data representations. The presence of occlusions in 3D space can further complicate the task of accurately detecting and tracking objects, as the occluded portions of an object may not be visible from all viewpoints.

Occlusions may be particularly common, and present a technical challenge, when tracking long objects and/or groups of objects. For example, challenges with tracking long objects may include accurately tracking the entire length of a long object (and in some case, its parts, such as the truck-trailer ensemble) through occluded regions and maintaining consistent identification throughout. As another example, a challenge with tracking a group of objects may include the inability to distinguish and identify individual object(s) in a densely packed group due to inter-object occlusion (e.g., by other object(s) in the group), thereby leading to insufficient tracking for such occluded objects (e.g., it may be difficult to track the motion of a first runner that is occluded by a second runner in multiple frames of a set of frames).

As another example, some object tracking systems may struggle to perform object tracking for dynamic scenes with numerous, densely-packed objects. For example, due to appearance ambiguity resulting from the dense packing and/or minimal detail resulting from low resolution frames, tracking of individual objects in such scenes may be extremely challenging. These challenges may be particularly common when individually tracking each object in a groups of objects, such as, for example, each cyclist in a group of cyclists.

Both groups of objects and long objects may give rise to a large, varying number of detections, and thus tracklets that need to be generated (e.g., one or more tracklets per object), as well as tracklet maintenance that needs to be handled for each generated tracklet. Performing object tracking (e.g., including generating and maintaining tracklets) for a large number of tracklets, associated with multiple objects in a scene, may be computationally expensive, and in some cases, it may be impractical to track all objects and maintain each tracklet individually. Further, at least for groups of objects in the scene, tracking each object individually may result in a waste of resources. Specifically, generating and maintaining a tracklet for each object may result in over-modeling of a scene, when all objects of the group move in a coordinated manner within the scene (e.g., each cyclist in a group of cyclist may be pedaling nearly the same speed and in the same direction over time) and one tracklet for the group may suffice for object tracking. Over-modeling of the scene may result in computational inefficiency and thus an unnecessary use of resources to obtain nearly the same information multiple times (e.g., each tracklet used to predict the motion of an object in the group may result in essentially the same prediction for each object).

In certain aspects, as described above, tracklet maintenance may include updating a state of an object associated with an existing tracklet each time a new detection is identified (e.g., such as in a current frame) as being associated with the existing tracklet. For example, a tracking filter associated with the existing tracklet may be updated with the new detection, which may include one or more states (e.g., velocity measurements, acceleration measurements, etc.) of the object associated with the tracklet. A technical problem of using this method of associating new detection(s) with an existing tracklet includes the fixed nature of the association. For example, once association decisions are made, they remain fixed even as new information emerges (e.g., detections associated with each tracklet remain fixed). While suitable for straightforward tracking scenarios with few objects, minimal occlusion, and low measurement noise, such approaches may encounter difficulties in complex operational settings like tracking long objects, such as trucks with trailers, or groups of objects, such as bikers and/or runners in densely populated scenes. In these challenging environments, ambiguities often arise that cannot be resolved within the current frame, leading to tracking errors for these object(s).

Certain aspects described herein overcome the aforementioned technical problems associated with current object tracking techniques and provide a technical benefit to the field of computer vision. For example, aspects described herein provide improved techniques for object tracking which may allow for adaptive tracklet generation and association. As described below, tracklet association may be used to identify tracklets that form a coherent tracklet based on one or more criteria indicating similarity between the tracklets. Tracklets determined to be associated may be clustered to form a clustered tracklet, which may be used in addition to, or alternative to, using individual tracklets for object tracking. The tracking techniques described herein may be applied to track a variety of objects including long objects with large tracklet lengths (e.g., trucks with trailers) and/or groups of objects with extended temporal presence (e.g., group of cyclists and/or a group of runners).

As described above, a tracklet may refer to a temporal sequence of detections associated with a single object over multiple consecutive frames (e.g., associated with a time period), where each detection of the sequence includes one or more states of the object. Thus, a tracklet may refer to a temporal sequence of states associated with the single object over the time period. The sequence of states for the object may represent a trajectory for the object over the time period. For example, an example state associated with each detection may include information about a location of the object in a scene over the time period. Thus, the temporal sequence of states, where each state represents the location of the object, may indicate a trajectory of the object over the time period.

Tracklet generation, as described herein, may include detecting one or more objects in a first set of frames as multiple detections, and determining state(s) associated with each detection. Detections with the same or similar states may then be associated to form a tracklet. As an illustrative example, five detections associated with five different frames (e.g., each associated with a respective timestamp), associated with an object of a same semantic class, and having similar velocities and headings (e.g., example states), may be linked to form a tracklet for the object.

Tracklet association, as described herein, may include clustering two or more tracklets to form a clustered tracklet, which may be used to improve trajectory prediction of one or more objects associated with the clustered tracklets. For example, a first tracklet with a first sequence of states may be compared to a second tracklet with a second sequence of states to determine if the first tracklet and the second tracklet together form a single coherent tracklet. States that are the same, or similar, between the tracklets may indicate that the tracklets are related and consistent, and thus are likely to form a coherent tracklet. As such, the tracklets may be clustered to create an association between the tracklets. This clustered tracklet may be used, in addition to or alternative to each individual tracklet, to improve the reliability and accuracy of tracking for object(s) associated with the individual tracklet(s). For example, a group of cyclists detected in a set of frames may include multiple similar states over the set of frames. As such, each tracklet associated with each cyclist may be clustered to form a single clustered tracklet. In certain aspects, the clustered tracklet may be used (in some cases, in the place of each individual tracklet) to predict a future trajectory for the cyclists.

In certain aspects, an association graph (which may be referred to herein simply as a “graph,” or an “association graph”) is generated to dynamically determine associations between detections of one or more objects (e.g., for tracklet generation) and/or between tracklets comprising sequences of detections (e.g., for tracklet association or tracklet clustering). For example, a scene of one or more objects may be represented as an association graph with nodes and edges. The graph may span multiple non-adjacent frames, in certain aspects ensuring temporal continuity and/or accommodating occlusions. Each node in the graph may represent a detection (e.g., of an object) in one of the non-adjacent frames. Each edge in the graph may indicate a potential association between a pair of nodes (e.g., potential association between states for a pair of detections associated with one or more objects). In certain aspects, each edge may be analyzed to generate a set of tracklet hypotheses, each tracklet hypothesis indicating the likelihood that the nodes associated with the edge being analyzed make up a single tracklet. In certain aspects, multiple edges between pairs of nodes belonging to different tracklets may be analyzed to generate a set of clustered tracklet hypotheses, each clustered tracklet hypothesis indicating the likelihood that the tracklets associated with the pairs of nodes form a coherent tracklet. In certain aspects, adaptive edge weighting and/or pruning techniques may be used to prioritize relevant associations for hypothesis generation to reduce the computational burden of creating the association graph.

In certain aspects, instead of using a predefined static graph, the graph may be assembled incrementally, with nodes and edges added and/or removed dynamically as new detections are obtained (e.g., such as from a current frame). Dynamically constructing the association graph based on spatial and temporal context, may beneficially allow for adaptability to changing scene dynamics and varying object behaviors. This adaptability may allow for the modification, addition, and/or removal of tracklets and/or clustered tracklets to handle occlusions and/or sudden changes in object behavior. As such, more accurate tracking of complex objects, such as long objects and/or groups of objects, may be enabled even in challenging environments.

In certain aspects, instead of generating a single graph, multiple graphs may be created. Each graph may be associated with a different resolution, and thereby a different level of granularity may be captured. For example, a first resolution graph (e.g., a higher resolution graph) may capture fine-grained details of object movements at a frame-by-frame level, while a second resolution graph (e.g., a lower resolution graph) may aggregate detections, and their associated states, over longer time intervals to capture broader trends in object movement. The resolution of the graph used for object tacking may depend on the application and/or the type of objects being tracked (e.g., a lower resolution graph may suffice for tracking multiple cyclists cycling together in a densely packed group).

In certain aspects, the object tracking techniques described herein provide various beneficial technical effects and/or advantages over conventional solutions, such as robust tracking performance of diverse objects in real-world environments, even in the presence of challenging conditions such as occlusions and/or and crowded scenes. In certain aspects, the improved tracking performance may be attributable to the dynamic nature of the association graph used to represent associations between detections, objects, and/or tracklets in a scene, the generation of multi-resolution graphs, the performance of tracklet clustering, and/or the use of adaptive edge weighting and/or pruning techniques for hypothesis generation. For example, object tracking techniques may not need to use the conventional sliding window approach for object tracking (described above), which may not be ideal for tracklet generation and/or management in challenging environments. Instead, in certain aspects, a dynamic graph may be created for dynamic tracklet management, such that tracklets can be initiated, retained, and/or deleted as nodes and/or edges of the graph are added and/or removed based on new detections in the scene over time. As such, in certain aspects, evolving scene dynamics may be captured, making the graph-based approach well-suited for object tracking. Further, in certain aspects, multi-resolution graph generation, which involves representing the temporal evolution of object trajectories at different levels of granularity, may allow for more effective handling of diverse behaviors of objects in a scene (e.g., speeds of cyclists in a scene), thereby improving association accuracy for tracklet and clustered tracklet generation. In certain aspects, tracklet clustering may enable the tracking of long objects and groups of objects with extended temporal presence despite potential occlusions and/or erratic movements by, for example, maintaining tracklet continuity between two or more tracklets. Tracklet clustering may also help to reduce object level tracklet maintenance by providing an alternative to tracking object(s) associated with multiple individual tracklets. Additionally, in certain aspects, the use of adaptive edge weighting and/or pruning techniques may contribute to efficient hypothesis generation and association while managing computational complexity during object tracking.

### Example Workflow for Object Tracking

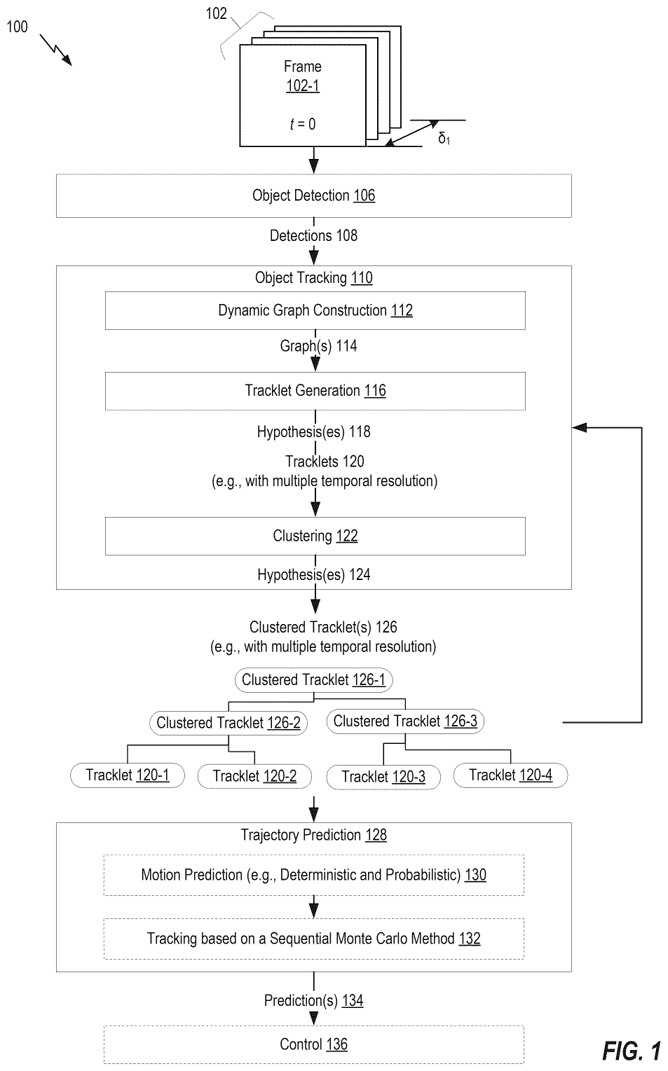

FIG. 1 depicts an example workflow 100 for object tracking, such as to track a group of objects and/or a long object. Using conventional techniques, a group of objects may be challenging to track over a period of time due to, for example, inter-object occlusions and sudden changes in object behavior. Using conventional techniques, a long object may be challenging to track over a period of time due to, for example, the difficulty in maintaining consistent identification for the object over multiple frames where the object is occluded (e.g., portions of the object are passing through occluded regions). Workflow 100 may help to overcome the technical challenges associated with tracking such objects using conventional techniques.

For example, workflow 100 begins with obtaining a set of frames 102, including at least a first frame 102-1. The set of frames 102 may include two or more frames, such as a sequence of frames from a video, frames from a scene captured by a light detection and ranging (LIDAR) sensor, fused frames combining information from multiple sensors, and/or any other suitable type of frame data. In certain aspects, the frame(s) 102 may be obtained from various sources, such as video sequences captured by cameras, frames from a scene provided by a LIDAR sensor, etc. In certain aspects, fused frames, also referred to as “fused sensor data,” may leverage data from both LIDAR sensor(s) and image sensor(s) (e.g., camera(s)), where at least one LIDAR sensor provides depth information, while at least one image sensor provides visual details for a scene.

In certain aspects, the set of frames 102 may include 3D frames or 3D representations, such as 3D point clouds (simply referred to herein as “point clouds”). For example, 3D sensor(s), such as LiDAR sensor(s), may be used to produce point clouds, which are collections of points (e.g., associated with objects) in 3D space for a scanned environment. In certain aspects, the set of frames 102 may include 2D frames or 2D representations, such as 2D images. For example, image sensor(s), such as camera(s), may be used to produce 2D images, which include pixels in 2D space for a scanned environment.

The set of frames 102 may include one or more objects (as in depictions of one or more objects). For example, in certain aspects, the set of frames 102 may include one or more long objects. In certain aspects, the set of frames 102 may include one or more groups of objects. In certain aspects, the set of frames 102 may include long object(s), group(s) of objects, and/or other types of object(s) in a dynamic, real-world scene. In certain aspects, at least one of the one or more objects included in the set of frames 102 may be occluded by another object included in the set of frames 102.

The set of frames 102 may include object(s) detected in the dynamic, real-world scene over a time window (δ). The number of frames included in the set of frames 102 may be based on a temporal resolution of the frames (e.g., the time period between each frame in the set of frames 102). Thus, the set of frames 102 may include multiple non-adjacent frames (e.g., frames that are associated with timestamps that are each separated by a period of time).

Although not meant to be limiting to this particular example, the set of frames may include a building and a long object, such as a truck pulling a trailer. In one or more frames of the set of frames 102, at least a portion of the long object may be occluded by the building. Different portions of the long object may be occluded in different frames, at least due to the elongated shape of the long object.

After obtaining the set of frames 102, workflow 100 proceeds with object detection 106. In certain aspects, objection detection 106 may include performing 3D object detection to detect one or more 3D objects in the set of frames 102 as a plurality of detections 108. In certain aspects, objection detection 106 may include performing 2D object detection to detect one or more 2D objects in the set of frames 102 as a plurality of detections 108. A detection may refer to the identification and localization of an object or object state(s) within a given frame of the set of frames 102. This identification can be represented by various data types, such as by bounding boxes, points, or clusters, depending on the sensor modality and the specific application. Thus, a detection may be a flexible concept that applies to various sensor modalities and data representations.

As an illustrative example, where the set of frames 102 includes 2D images, a detection may be represented by a bounding box that encloses the detected object (e.g., a car, pedestrian, or cyclist). The bounding box may be defined by its coordinates, which specify the object's position within the image.

In certain aspects, object(s) in the set of frames 102 may be identified using one or more object detection models applied to the set of frames 102. Such models may analyze visual and depth information to locate and classify objects within the scene captured by the set of frames 102 as the plurality of detections 108. Example object detection models may include BEVFusion, BEVDET, and LargeKernel3D, to name a few.

In certain aspects, each detection 108, associated with a single object in the set of frames, is associated with one or more object states (simply referred to herein as “states”). Example states associated with a detection 108 may include a size of the object associated with the detection 108; a location of the object in a scene; an orientation of the object; a pose estimation of the object (e.g., detailed pose information, such as joint angles or body orientation in the case of human and/or animal tracking); one or more shape descriptors (e.g., descriptors or features that capture the aspect ratio, elongation, curvature, etc.) associated with the object; one or more visual features (e.g., an appearance) of the respective object; a velocity of the object; an acceleration of the object; a heading of the object; a semantic class (e.g., classification of the object type, such as pedestrian, vehicle, cyclist, etc.) associated with the object; a semantic class confidence score (e.g., a measure of the confidence in the classification of the semantic class); a trajectory score (e.g., a measure of the confidence associated with a predicted object trajectory, such as a confidence level) associated with the object; one or more confidence scores indicating a reliability of the detection 108; a trajectory standard deviation (e.g., which may provide insight into trajectory uncertainty); time elapsed since a last detection of the object (e.g., such as in a prior frame of the set of frames 102); dynamic(s) of the scene; an occlusion state of the object (e.g., indicating whether the object is currently occluded and/or the extent of the occlusion, such as partial or full occlusion); one or more interaction features (e.g., features indicating interaction with other objects or agents in the scene, such as proximity to other objects, predicted collision course, etc.); an environmental context (e.g., information about the environment around the object, such as a road type, weather conditions, etc.); an appearance change rate (e.g., the rate at which the appearance of the object changes over time, such as due to lighting changes, deformation, etc.).; a measure of a consistency of the object over one or more frames (e.g., including information that may be relevant for detecting whether an object is fragmented or being tracked as multiple entities incorrectly); a tracking history of the object (e.g., historical data points and/or tracklet history that reflects past states. which may be used to predict future states); a predicted future position of the object (e.g., a predicted position of the object in the next frame(s), based on current motion and dynamics); a sensor modality confidence score (e.g., confidence scores related to the specific sensor modality, such as LiDAR or camera(s), used to detect the object); scene flow information (e.g., information about the relative 3D motion of the object within the scene, which may aid in understanding dynamic environments); and/or optical flow information (e.g., information about the relative 2D motion of the object within the scene, which may aid in understanding dynamic environments).

Continuing with the example described above, object detection 106 may include detecting two objects as multiple detections 108 in the set of frames 102. More specifically, the first object detected may include the building, and the second object detected may include the truck-trailer combination. A first subset of detections 108 may belong to the building, and a second subset of detections 108 may belong to the truck-trailer combination. For example, a first respective detection 108 in each frame, such as a first respective bounding box in each frame, may represent the truck as it moves from frame to frame. Further, a second respective detection 108 in each frame, such as a second respective bounding box in each frame, may represent the trailer as it moves from frame to frame. Example states associated with each of the first respective detections 108 may include information about an object type and objection location of the truck as it moves from frame to frame. Similarly, example states associated with each of the second respective detections 108 may include information about an object type and objection location of the trailer as it moves from frame to frame.

Workflow 100 then proceeds with object tracking 110. Object tracking 110 may include multiple object tracking and/or group tracking. Multiple object tracking may refer to tracking one or more objects in a scene (e.g., such as object(s) detected as detections 108 via object detection 106), while keeping a unique identifier for each object. Group tracking may refer to tracking multiple objects in a scene based on a single unique identifier associated with each of the multiple objects (e.g., such that multiple objects are tracked together).

Object tracking 110 may result in the generation of one or more clustered tracklets 126 (e.g., shown as clustered tracklets 126-1 through 126-3) and/or one or more tracklets 120 (e.g., shown as tracklets 120-1 through 120-4). Each tracklet 120 generated during object tracking 110 may be associated with one object of the one or more objects detected during object detection 106. Each tracklet 120 may include a respective sequence of detections 108, and more specifically, a respective sequence of states associated with the sequence of detections 108 and associated with the object associated with the respective tracklet 120. The respective sequence of states associated with each tracklet 120 may represent a respective trajectory for the respective object associated with the respective tracklet 120.

In certain aspects, object tracking 110 includes (1) dynamic graph construction 112, (2) tracklet generation 116, and/or (3) hierarchical clustering 122.

Dynamic graph construction 112 may include generating one or more graphs 114 for the first set of frames 102. For example, to generate the graph(s) 114, dynamic graph construction 112 may include (1) dense graph construction, (2) sparse graph construction, (3) temporal resolution adjustment (e.g., for multi-resolution graph construction), and/or (4) adaptation.

Dense graph construction may include generating a first graph with multiple nodes and multiple edges. For example, a number of nodes added to the first graph (e.g., the dense graph) may be based on a number of detections in the set of frames 102. Put differently, each detection 108 (e.g., associated with one object) may cause one node to be added to the first graph. Further, an edge may be generated between each pair of nodes included in the graph (e.g., including (1) edges between nodes, such as corresponding to different objects, within a frame; and/or (2) edges between nodes, such as corresponding to the same or different objects, across frames).

Tracklet generation 116 may include evaluating a similarity of common state(s) associated with each node pair connected via an edge. Here, a common state may refer to a state type associated with both nodes in a node pair (e.g., connected via an edge) (e.g., states for a first node may include velocity and acceleration, while states for a second node may include velocity and heading; thus, the only common state between the nodes may include the velocity). Evaluating the similarity of a node pair's common state(s), such as for node association in tracklet generation, may be based on one or more criteria.

In certain aspects, the criteria may include a distance threshold, such as a predefined or dynamically calculated distance threshold. A distance metric between locations of the nodes in the node pair may be calculated and compared against the distance threshold. The distance metric may be a spatial distance (e.g., a Euclidean distance in an image plane or a 3D space) or a combination of spatial and temporal distances. A distance metric for the node pair that satisfies the distance threshold (e.g., distance metric<distance threshold) may indicate that the nodes being evaluated, or their associated detections 108, are likely related, while the opposite is may be true when the distance metric does not satisfy the distance threshold.

For example, a first node may be associated with a first detection of a first cyclist in a first frame (e.g., of a scene), and a second node may be associated with a second detection of a second cyclist in the first frame. The first and second nodes may be connected via an edge in the graph. The first detection may include information about a location of the first cyclist in the scene. The second detection may include information about a location of the second cyclist in the scene. A distance metric may be calculated as a difference between the first location of the first cyclist (e.g., associated with the first detection) and the second location of the second cyclist (e.g., associated with the second detection). This distance metric may be compared to the distance threshold to determine if the distance threshold is satisfied. If the distance threshold is satisfied, then the first detection of the first cyclist and the second detection of the second cyclist may be determined to be sufficiently close, thereby indicating that an association may exist between the first node and the second node (e.g., between the first detection and the second detection).

As another example, a first node may be associated with a first detection of a first cyclist in a first frame (e.g., of a scene), and a second node may be associated with a second detection of the same first cyclist in a second frame (e.g., across-frame detections). The first and second nodes may be connected via an edge in the graph. The first detection may include information about a location of the first cyclist in the scene at a first timestamp associated with the first frame. The second detection may include information about a location of the second cyclist in the scene at a second timestamp associated with the second frame. A distance metric may be calculated as a difference between the first location of the first cyclist (e.g., in the first frame) and the second location of the first cyclist (e.g., in the second frame). This distance metric may be compared to the distance threshold to determine if the distance threshold is satisfied. If the distance threshold is satisfied, then the first detection of the first cyclist and the second detection of the first cyclist may be determined to be associated, such as for tracklet generation across the first and second frame.

In certain aspects, the criteria may include a similarity threshold, such as an appearance similarity threshold, a motion pattern similarity threshold, a semantic class similarity threshold, a velocity similarity threshold, and/or other feature thresholds. A similarity metric (e.g., based on appearance, motion patterns, object class, velocity, etc.) between the nodes in the node pair may be determined and compared against the similarity threshold. A similarity metric for the node pair that satisfies the similarity threshold (e.g., similarity metric>similarity threshold) may indicate that the nodes being evaluated, or their associated detections 108, are likely related, while the opposite may be true when the similarity metric does not satisfy the similarity threshold.

For example, a first node may be associated with a first detection of a first cyclist in a first frame (e.g., of a scene), and a second node may be associated with a second detection of a second cyclist in the first frame. The first and second nodes may be connected via an edge in the graph. The first detection may include information about a velocity of the first cyclist in the scene. The second detection may include information about a velocity of the second cyclist in the scene. A similarity metric (e.g., based on velocity) may be calculated as a difference between the velocity of the first cyclist (e.g., associated with the first detection) and the velocity of the second cyclist (e.g., associated with the second detection). This similarity metric may be compared to a similarity threshold (e.g., at least based on velocity) to determine if the similarity threshold is satisfied. If the similarity threshold is satisfied, then the first detection of the first cyclist and the second detection of the second cyclist may be determined to be traveling the same speed in the scene, thereby indicating that an association may exist between the first node and the second node (e.g., between the first detection and the second detection).

In certain aspects, the criteria may include a temporal consistency threshold that considers the temporal alignment or overlap of prior detections (e.g., such as in previous frames) associated with the node pair/detections being evaluated. A temporal consistency metric between the nodes in the node pair may be determined and compared against the temporal consistency threshold. A temporal consistency metric for the node pair that satisfies the temporal consistency threshold (e.g., temporal consistency metric>temporal consistency threshold) may indicate that the nodes being evaluated, or their associated detections 108, are likely related, while the opposite may be true when the temporal consistency metric does not satisfy the temporal consistency threshold.

For example, a first node may be associated with a first detection of a first cyclist in a first frame (e.g., of a scene), and a second node may be associated with a second detection of a second cyclist in the first frame. The first and second nodes may be connected via an edge in the graph. The first detection may include information about a temporal consistency of the first cyclist in the scene, for example, indicating that the first cyclist was detected in the last five frames that were obtained. The second detection may include information about a temporal consistency of the second cyclist in the scene, for example, indicating that the second cyclist was also detected in the last five frames. A temporal consistency metric may be calculated as a difference between the temporal consistency of the first cyclist (e.g., associated with the first detection) and the temporal consistency of the second cyclist (e.g., associated with the second detection). This temporal consistency metric may be compared to the temporal consistency threshold to determine if the temporal consistency threshold is satisfied. If the temporal consistency threshold is satisfied, then the first detection of the first cyclist and the second detection of the second cyclist may be determined to have a same temporal presence (e.g., are temporally aligned), thereby indicating an association between the first node and the second node (e.g., between the first detection and the second detection).

In certain aspects, evaluating the similarity of a node pair's common state(s), such as for node association in tracklet generation 116, may include evaluating the likelihood that the node pair's common state(s) are associated. For example, a likelihood ratio test may be performed to determine whether the nodes of the node pair are associated.

A likelihood ratio is a statistic expressing the relative likelihood of some data or event given two competing models. The likelihood ratio (LR) (also referred to herein as the “likelihood ratio statistic”) may be written as:

$$L R = \frac{L ( {θ}_{0} )}{L ( {θ}_{α} )}$$

where, L(θ₀) is the first likelihood of a null hypothesis (H₀: θ=θ₀) being correct, and is calculated as:

$$L ( {θ}_{0} ) = {f}_{n} ( {X}_{1} , {X}_{2} … , {X}_{n} \vert {θ}_{0} )$$

and L(θ_{α}) is the second likelihood of an alternate hypothesis (H_{α}: θ=θ_{α}) being correct, and is calculated as:

$$L ( {θ}_{α} ) = {f}_{n} ( {X}_{1} , {X}_{2} … , {X}_{n} \vert {θ}_{α} )$$

where fₙ(X₁, X₂ . . . , Xₙ|θ) is a probability density distribution for a random sample, X₁, X₂ . . . , Xₙ, with a parameter θ. A null hypothesis (H₀: θ=θ₀) is a statement about a population that is assumed to be true unless it can be shown to be incorrect, while an alternate hypothesis (H_{α}: θ=θ_{α}) is a claim about the population that is contradictory to H₀ and is concluded when H₀ is rejected.

Here, the null hypothesis (H₀: θ=θ₀) may be a hypothesis that the nodes of a node pair are associated based on their respective common states, while the alternate hypothesis (H_{α}: θ=θ_{α}) may be a hypothesis that the nodes of the node pair are not associated based on their respective common states. A first likelihood (L(θ₀)) (e.g., a first hypothesis 118) that the nodes of the node pair are associated and a second likelihood (L(θ_{α})) (e.g., a second hypothesis 118) that the nodes/detection of the node pair are not associated may be determined to computer the likelihood ratio statistic

$$L R = \frac{L ( {θ}_{0} )}{L ( {θ}_{α} )} .$$

The likelihood ratio statistic determined for the node pair may be used to associate the node pair or not by comparing the likelihood ratio statistic to a likelihood ratio test threshold, k. In certain aspects, the likelihood ratio test threshold, k, may be based on one or more criteria, such as the distance threshold, one or more of the similarity thresholds, and/or the temporal consistency threshold, described above.

As such, when comparing the likelihood ratio statistic to a likelihood ratio test threshold, k, the node pair may be determined to be associated (e.g., a third hypothesis 124-3) when:

$$\frac{L ( {θ}_{0} )}{L ( {θ}_{α} )} \geq k$$

and the node pair may be determined not to be associated when:

$$\frac{L ( {θ}_{0} )}{L ( {θ}_{α} )} < k$$

In certain aspects, a log likelihood ratio (also referred to as a “log likelihood ratio statistic”) may be determined, instead of a likelihood ratio, and compared to a log likelihood ratio test threshold to determine the association, if any, between a node pair. A log likelihood ratio statistic may be expressed as the logarithmic function of likelihood ratio.

This evaluation may be performed for each node pair to generate a hypothesis 118 for each node pair indicating the association, if any, between the respective node pair.

Evaluating every node pair (e.g., connected via an edge) in the graph to determine an association between the nodes in the node pair may, in some cases, become computationally intractable due to the exponential number of two node combinations, especially for a larger number of detections (e.g., such as for long objects). Accordingly, in certain aspects, dynamic graph construction 112 further includes sparse graph construction.

Sparse graph construction may begin after generating the first graph, e.g., the dense graph. For example, the sparse graph construction may start with the dense graph and use one or more techniques to reduce the number of edges, and more specifically node pairs in the graph that do not need to be evaluated.

A first technique for reducing edges in the graph may include probabilistic edge pruning of low probability edges (e.g., low probability edges are edges having a low probability of connecting nodes that are associated). In certain aspects, probabilistic edge pruning may include performing class-based and/or distance-based edge deletion to reduce a number of edges in the graph. Class-based edge deletion may include removing edges in the graph that are used to connect two nodes associated with objects having different semantic classes (or that do not meet a semantic class similarity threshold). Distance-based edge deletion may include removing edges in the graph that are used to connect two nodes associated with objects having locations a distance apart that do not meet a distance threshold. Put differently, edges between node pairs associated with objects that have excessive spatial separation may be removed from the graph. In certain aspects, pruning decisions are based on probabilistic measures of association confidence, thereby allowing for efficient reduction of hypothesis space while preserving high-confidence associations for node association (e.g., detection association such as for tracklet generation 116).

In scenarios involving long objects, where occlusions and/or complex spatial relationships are common, probabilistic graph pruning may help to manage the computational complexity of the assignment problem. Similarly, for groups of objects (e.g., such as with frequent occlusions), probabilistic graph pruning may allow a tracking system to adaptively filter out spurious associations and focus on robust detections.

A second technique for reducing edges in the graph, such as during sparse graph construction, may include adaptive edge weighting. Adaptive edge weighting may refer to the dynamic adjustment of the importance and/or strength of one or more edges in the graph, such as based on contextual information. In the context of tracklet generation, adaptive edge weighting may be used to prioritize relevant associations between detections while mitigating the impact of noise and/or outliers. This weighting strategy may take into account common state(s) between a pair of nodes, such as object velocities, motion patterns, and scene dynamics, to determine the significance of each edge in the graph. For example, edges representing associations between a pair of nodes with similar velocities and trajectories may be assigned higher weights, indicating stronger correlations between these nodes. By adaptively adjusting edge weights, the graph may shift its focus towards meaningful associations (e.g., associated with higher weights) while filtering out irrelevant and/or spurious edges between nodes. For example, only nodes connected via edges associated with weights above a threshold maybe be evaluated to determine if an association between the nodes exists (e.g., such as to perform tracklet generation 116 or clustering 122, as described in detail below), without evaluating the nodes connected via edges associated with respective weights below the threshold.

After performing probabilistic graph edge pruning and/or adaptive edge weighting, evaluation may be performed for each node pair (1) with an edge remaining between the nodes in the sparse graph and/or (2) having a weight greater than a minimum weight threshold. A hypothesis 118 indicating the association, if any, between each respective node pair for which evaluation is performed may be generated based on the evaluation.

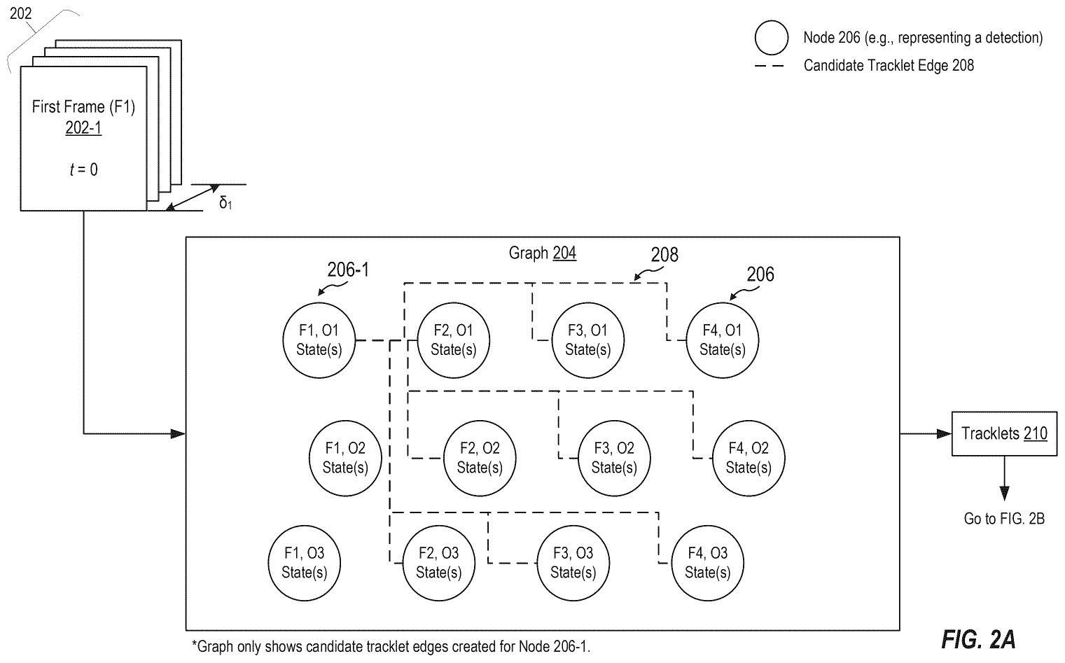

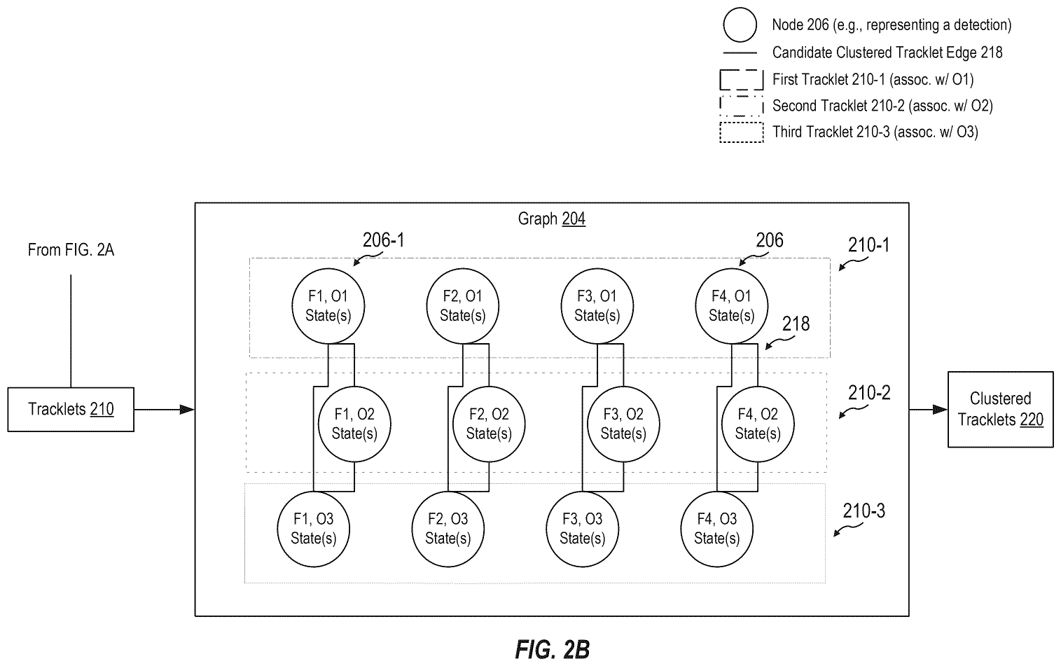

In certain aspects, one or more hypotheses 118 may be used to generate tracklets 120, or more specifically, assign multiple nodes (e.g., detections 108) associated with the one or more hypotheses 118 to a same tracklet 120. Assigning multiple nodes to a tracklet 120 may result in the generation of a sequence of detections (including one or more states) associated with an object over the set of frames 102. Example tracklet generation using an association graph is depicted and described below with respect to FIG. 2A.

For the example described above, dynamic graph construction 112 may result in the creation of at least one graph 114 having nodes associated with at least the truck-trailer combination. Edges evaluated between one or more of these node pairs may result in (1) the association of a first set of nodes representing detections of the truck and (2) the association of a second set of nodes representing detections of the trailer. Accordingly, a first tracklet 120, including a temporal sequence of detections and states for the truck, and a second tracklet 120, including a temporal sequence of detections and states for the trailer, may be generated. Two tracklets 120 may be created even though the truck-trailer combination represents one object in the scene.

Workflow 100 then proceeds with clustering 122. Clustering 122 may include evaluating a similarity of common state(s) associated with node(s) of different tracklets (e.g., tracklets having one or more nodes connected between them via one or more edges). Evaluating the similarity between tracklet node(s), and more specifically between common state(s), such as for tracklet association in clustering 122, may be based on one or more criteria. In certain aspects, clustering 122 focuses on tracklets 120 that become similar over long time windows (e.g., ˜1-10 seconds) (e.g., such as a group of pedestrians, a group of cyclists, a convoy of trucks, a group of vehicles in traffic, etc.).

Similar to performing node association for tracklet generation 116, for tracklet association (e.g., to generate one or more clustered tracklets 126 during clustering 122), the criteria may include a distance threshold, a similarity threshold, or a temporal consistency threshold, among others. In certain aspects, evaluating the similarity of common state(s) associated with node(s) of different tracklets may include evaluating the likelihood that the tracklets together from a coherent tracklet based on their respective common states. For example, a likelihood ratio test may be performed to determine whether the tracklets are associated.

Here, the null hypothesis (H₀: θ=θ₀) may indicate that two or more tracklets are associated and together form a coherent tracklet based on their respective common states. The alternate hypothesis (H_{α}: θ=θ_{α}) may indicate that two or more tracklets are not associated and together do not form a coherent tracklet based on their respective common states. A first likelihood (L(θ₀)) (e.g., a first hypothesis 124) that the tracklets are associated and form a coherent tracklet and a second likelihood (L(θ_{α})) (e.g., a second hypothesis 124-2) that the tracklets are not associated and do not form a coherent tracklet may be determined to computer the likelihood ratio statistic

$$L R = \frac{L ( {θ}_{0} )}{L ( {θ}_{α} )} .$$

The likelihood ratio statistic determined for the tracklets being evaluated may be used to associate the tracklets (e.g., for clustering 122) or not by comparing the likelihood ratio statistic to a likelihood ratio test threshold, k. In certain aspects, the likelihood ratio test threshold, k, may be based on one or more criteria, such as the distance threshold, one or more of the similarity thresholds, and/or the temporal consistency threshold, described above.

In certain aspects, a log likelihood ratio statistic may be determined instead of the likelihood ratio statistic and compared to a log likelihood ratio test threshold to determine the association, if any, between the tracklets.

A likelihood ratio statistic or a log likelihood ratio statistic determined for the tracklets may leverage multiple sources of information, such as multiple common states including, for example, kinematics, appearance similarity, confidence scores, etc., to determine the ratio. As such, a fusion process may be performed to dynamically weight the contributions of each common state based on their relevance and/or reliability in the current context. This adaptive fusion may enhance the robustness and accuracy of likelihood ratio and/or log likelihood ratio computation, particularly in challenging scenarios with occlusions and/or noisy sensor data.

For example, for a long object such as a truck with a trailer, adaptive fusion of likelihood ratio statistics and/or log likelihood ratios may enable the tracking system to effectively integrate information from multiple sources, such as kinematics (e.g., truck and trailer velocities), appearance similarity (e.g., visual features of the vehicles), and/or confidence scores (e.g., detection reliability), to name a few. This holistic fusion approach may help to enhance the tracking system's ability to accurately discriminate between true associations and false positives, especially in challenging scenarios. Similarly, for a group of objects such as a group of cyclists or runners, adaptive likelihood ratio statistic and/or log likelihood ratio statistic fusion may enable the tracking system to leverage diverse sources of information, such as motion dynamics, appearance characteristics, and/or contextual cues (e.g., group formations), among others. By dynamically weighting the contributions of each factor based on their relevance and/or reliability, the tracking system may be able to maintain robust performance across varying environmental conditions and object behaviors.

In certain aspects, this evaluation may be performed for multiple tracklet groups (e.g., including two or more tracklets in the graph 114) to generate a hypothesis 124 for the tracklet group indicating the association, if any, between the tracklets in the group. For example, a hypothesis 124 may indicate that it is likely that the group of tracklets form a coherent tracklet or indicate that it is not likely that the group of tracklets form a coherent track. In certain aspects, the evaluation may be performed for tracklets having edge(s) between their respective nodes (e.g., such as after performing probabilistic edge pruning and/or adaptive edge weighting to remove one or more edges), without performing the evaluation for tracklet groups that include tracklets with no, or minimal, edges between them.

In certain aspects, one or more hypotheses 124 may be used to generate clustered tracklets 126, or more specifically, cluster two or more tracklets 120 that are determined to form a coherent tracklet. Example clustering 122, or clustered tracklet generation, using an association graph is depicted and described below with respect to FIG. 2B.

For the example described above, clustering 122 may include determining a likelihood ratio statistic (or a log likelihood ratio statistic) for the first tracklet 120 generated for the truck and the second tracklet 120 generated for the trailer. The likelihood ratio statistic may comprise a ratio of the likelihood that the first and second tracklets 120 form a coherent tracklet to the likelihood that the first and second tracklets 120 do not form a coherent tracklet. For this example, when the likelihood ratio statistic is compared to the likelihood ratio test threshold, k, (or the log likelihood ratio statistic is compared to the log likelihood ratio test threshold) the comparison may indicate that the first and second tracklets 120 are associated and form a coherent tracklet. Thus, the first and second clusters may be clustered to form a clustered tracklet 126.

In certain aspects, multiple graphs 114 are constructed at dynamic graph construction 112, where each graph 114 is associated with a different resolution (referred to herein as “multi-resolution graph construction”). Multi-resolution graph construction may allow for the incorporation of varying temporal scales, which may enable more flexible and accurate tracklet generation 116. For example, multi-resolution graph construction may include creating multiple versions of a graph 114 created based on the temporal resolution of the first set of frames 102. Each graph 114 created may represent object trajectories at a different temporal resolution or at a different level of granularity. For example, one graph 114 constructed may capture fine-grained details of object movements at a frame-by-frame level, while another graph 114 may aggregate observations over longer time intervals to capture broader trends in object trajectories. By incorporating multiple levels of granularity, the temporal resolutions of the graphs 114 may be adaptively adjusted based on the complexity of the scene and/or the dynamics of the objects being tracked. As such, multi-resolution graph construction may allow for more effective handling of varying temporal scales, thereby improving tracklet generation 116 and tracklet association accuracy, such as for clustering 122. This may enable more effective handling of varying temporal scales, improve tracklet generation and association accuracy, and enhance the system's ability to detect complex objects like trucks with trailers in challenging environments.

As an illustrative example of the use of multi-resolution graph construction, in one case used to track a group of cyclists, multi-resolution graph construction may enable the tracking system to adaptively adjust the temporal resolution of the graph based on the speed and behavior of the tracked cyclists. For example, the group of cyclists may include both slow-moving and fast-moving cyclists in the scene. Multi-resolution graphs 114 may be created to include different versions representing cyclist trajectories at varying temporal resolutions (e.g., frame rates). A graph 114 created with a fine temporal resolution may capture detailed movements of slow-moving cyclists, while a graph 114 created with a more coarse resolution may aggregate observations over longer time intervals to capture the broader trends of the fast-moving cyclists in the scene. By incorporating multiple levels of granularity, the tracking system may be able to effectively handle the diverse speeds and/or behaviors of cyclists in the scene, thereby helping to improve tracklet generation and association accuracy. This adaptive adjustment of temporal resolution may help the tracking system to accurately track both slow-moving and fast-moving cyclists, even in complex and dynamic environments.

In certain aspects, the temporal resolution adjustment may occur after an initial graph 114 is constructed based on the set of frames 102 (e.g., the original frames). In certain aspects, the temporal resolution adjustment involves reducing the temporal resolution of the initial graph 114. For example, reducing the temporal resolution may include aggregating data from multiple frames of the set of frames 102 into larger time intervals and/or simplifying the initial graph 114 by removing node(s) and/or edge(s) that represent less critical information. The temporal resolution may be reduced to construct a graph 114 that is less detailed and/or more manageable than the initial graph 114 (e.g., constructed based on the set of frames 102). In certain aspects, the temporal resolution adjustment may include increasing the temporal resolution of the initial graph 114. For example, increasing the temporal resolution may involve adding more granular temporal detail to the initial graph 114, such as by incorporating additional intermediate frames and/or predictions between existing frames in the set of frames 102 (e.g., adding predicted and/or interpolated frame(s) to provide finer temporal details). In certain aspects, this may be accomplished using interpolation method(s) and/or ML model(s) trained to predict intermediate states.

In certain aspects, multiple hypotheses 124 may be created during clustering 122, where each hypothesis 124 is generated to indicate the likelihood of two or more tracklets 120 forming a coherent tracklet based on some particular criteria. The criteria may range from less restrictive criteria to more restrictive criteria. For less restrictive criteria, a clustered tracklet 126 may be less strict as to which tracklets 120 form a coherent tracklet when determining their association. On the other hand, for more restrictive criteria, a clustered tracklet 126 may be stricter as to which tracklets 120 form a coherent tracklet when determining their association. As an illustrative example, three tracklets 120 may exist. Distances between first locations (e.g., example states) associated with a first tracklet 120 and second locations associated with a second tracklet 120 may be smaller than distances between the first locations associated with the first tracklet 120 and third locations associated with a third tracklet 120, as well as smaller than distances between the between the second locations associated with the second tracklet 120 and the third locations associated with the third tracklet 120 (e.g., the first and second tracklets 120 may be associated with one or more objects that are closer together in the scene than an object associated with the third tracklet 120). When clustering using less restrictive criteria based on distances between the tracklets 120, a clustered tracklet 126 may be generated to include the first, second, and third tracklets 120. However, when clustering using more restrictive criteria based on distances between the tracklets 120, a clustered tracklet 126 may be generated to include only the first and second tracklets 120, without the third tracklet 120.

A hierarchy may be used to organize the hypotheses 124 into multiple levels. For example, as shown in FIG. 1, clustered tracklets 126-1 through 126-3, generated for tracklets 120-1 through 120-4 may be organized in a hierarchy. Clustered tracklet 126-1 may include all of tracklets 120-1 through 120-4 based on less restrictive criteria enabling the clustering of all tracklets 120-1 through 120-4. However, clustered tracklet 126-2 may only include tracklets 120-1 and 120-2, while clustered tracklet 126-3 may only include tracklets 120-3 and 120-4 due to using more restrictive criteria.

In certain aspects, hypotheses 124 of each level (used for clustered tracklet 126 generation) may be generated based on different temporal resolutions of granularity to capture both fine-grained details and coarse trends in object movements. This hierarchical structure of hypotheses 124 may help enable efficient exploration of the hypothesis space while maintaining flexibility to capture diverse object behaviors. For example, for a group of cyclists, hierarchical hypotheses 124 generation may be used to capture both individual movements and group behaviors. At finer levels of granularity, hypotheses 124 may focus on tracking individual bikers or runners, while at coarser levels, hypotheses 124 may represent the overall movement patterns of cyclists in the group.

In certain aspects, after generating clustered tracklet(s) 126, at least one clustered tracklet may be propagated back in time, such as to a time when the clustering wasn't establish and/or true. This may help to establish an association back in time between objects associated with a clustered tracklet later in time (but for which may not be associated earlier in time).

Workflow 100 then proceeds with trajectory prediction 128. Trajectory prediction 128 may include determining a trajectory for a set of the object(s) (e.g., where a set may include one or more, or all object(s)) identified in the set of frames 102. In certain aspects, a trajectory for the set of object(s) may be determined based on a clustered tracklet 126 associated with the set of object(s). For example, a state of one or more objects associated with the clustered tracklet 126 may be used to predict a future state for the one or more objects. In certain aspects, a tracking filter may be used to predict the future state for the one or more objects. The future state predicted for one or more objects in the scene may constitute a prediction 134 output based on performing trajectory prediction 128.

For the example described above, the truck may be associated with the first tracklet 120 and the trailer may be associated with the second tracklet 120. The first and second tracklets may also be clustered to form a clustered tracklet 126 that is associated with both the truck and trailer. Instead of using the individual tracklets 120 associated with each of the truck and the trailer, the clustered tracklet 126 may be used to determine a future state of the truck and the trailer (e.g., a prediction 134). Put differently, instead of estimating the trajectory of the truck and the trailer separately, a future trajectory for the truck-trailer combination may be estimated. The truck and the trailer may be expected to have a same trajectory given the truck and trailer are associated with a single object, such as a long object in the scene, which was fragmented into two different tracklets 120.

In certain aspects, a hybrid motion model, a Sequential Monte Carlo (SMC) method, and/or adaptive particle resampling and weighting strategies may be combined to perform trajectory prediction 128.

For example, in certain aspects, motion prediction 130 for one or more objects in the scene used to predict a future trajectory of the one or more objects, may integrate both deterministic motion equation(s) and probabilistic maneuver detection (e.g., to create a hybrid motion model). The deterministic motion equation(s) may be used to model the regular motion behavior of object(s), and the probabilistic maneuver detection may be used to detect and model sudden changes and/or maneuvers in object motion.

For example, when tracking a vehicle on a highway, deterministic motion equation(s) may be used to predict the vehicle's path using constant velocity or constant acceleration, while probabilistic maneuver detection may be used to identify potential lane changes, sudden braking, and/or acceleration of the vehicle, such as based on traffic conditions and/or the proximity of other vehicle(s) to the vehicle. As another example, when tracking a pedestrian in an urban environment, deterministic motion equation(s) may use a constant velocity to predict the pedestrian's straight-line path, while probabilistic maneuver detection may be used to detect abrupt turn(s) by the pedestrian and/or stop(s) by the pedestrian near crosswalks, intersections, and/or obstacles based on environmental cues. As another example, when tracking a cyclist in a crowded area, deterministic motion equation(s) may predict the cyclist's movement along a consistent trajectory with regular speed, while probabilistic maneuver detection may be used to identify sudden swerving by the cyclist and/or changes in direction of cyclist, such as due to nearby pedestrian(s) and/or other cyclist(s).

The hybrid motion model, combining elements of constant velocity and maneuver-based motion, may beneficially capture the diverse motion pattern(s) of object(s) in the scene. For example, the hybrid motion model may help to accurately capture the complex motion dynamics of long objects, such as trucks with trailers, which often exhibit both linear motion and occasional abrupt maneuvers or changes in direction. Similarly, for groups of objects, such as a group of cyclists, the hybrid motion model may incorporate variations in speed and/or direction to better anticipate movements of objects in the group, especially in crowded and/or dynamic environments. By using a combination of the deterministic motion equation(s) and the probabilistic maneuver detection, tracking object(s) in the scene, such as object(s) exhibiting both smooth and abrupt motion changes (e.g., such as trucks changing lanes and/or cyclists making sharp turns), may improve the accuracy of the trajectory prediction 128 for object tracking.

The SMC method, often referred to as “a particle filter” (e.g., where a particle filter refers to a generic algorithm for a function optimization where the solution search space is searched using particles (sampling)), is a probabilistic technique that may be used for estimating the state of a system and/or an object over time. In the context of trajectory prediction and object tracking, the SMC method may use a set of “particles” to represent possible future states of a tracked object. Each particle may represent an individual sample or hypothesis about the object's state (e.g., position, velocity, and/or other attributes, providing a hypothesis about the object's state). A collection of particles may provide a probabilistic distribution over possible states, allowing the SMC method, or particle filter, to handle uncertainty and non-linearities in a system's and/or object's dynamics.

In certain aspects, instead of using a fixed resampling scheme, the SMC method may use adaptive particle resampling and weighting. For example, with adaptive particle resampling and weighting, each particle associated with an object may be weighted according to how well the particle (e.g., the hypothesis) matches observed data for the object. A weight assigned to a particle may represent the importance of the particle. A weight assigned to a particle (i.e., importance of the particle) may be based on how well the state(s) of an object, represented by the particle, match observed data for the object. Over time, with adaptive particle resampling and weighting, the number of particles and/or their respective weights may be dynamically updated to reflect the latest observations and/or the current tracking scenario's complexity. For example, the adjustment of particles and/or their respective weights may be updated to reflect the latest observations and the current tracking scenario's complexity and/or uncertainty. By adaptively increasing the number of particles in regions of high uncertainty or abrupt motion changes (e.g., trailer articulation for trucks), the SMC method may help to provide more accurate and robust tracking results.

This update of the number of particles and/or their respective weights may happen continuously over time as the tracking progresses (e.g., including after clustered tracklet(s) 126 are created). For example, the SMC method, e.g., the particle filter, may be updated with the number of particles and/or their respective weights to predict the future state of an object. As new observations are received, the SMC method may update the weight(s) of one or more particle(s) and resample them to reflect the updated estimate of the object's state. Resampling, in the context of the SMC method, may refer to a process of selecting and duplicating particle(s) with higher weights (i.e., those that better match the observations) while discarding particle(s) with lower weights. Resampling may help to focus computational resources on the most likely states of a system or object, improving the accuracy of the SMC method with respect to tracking and updating the state of an object over time. Resampling may be an important step in the SMC method to prevent particle degeneracy and may help to ensure robust tracking over time. By performing adaptive particle resampling and weighting, the SMC method may be used for updating the state of a system or object for future state prediction.

In certain aspects, the SMC method, incorporating adaptive resampling and weighting strategies, may be used for updating the state of a clustered tracklet. For example, the SMC method may adjust particle weight(s) and/or perform resampling based on the spatial-temporal distribution of particles and/or the consistency of states over time for the clustered tracklet (e.g., associated with object associated with the clustered tracklet) to predict a future state of the objects associated with the clustered tracklet. For example, adaptive resampling may help to concentrate particles in regions of high probability density, thereby leading to more accurate and efficient tracking of the clustered tracklet and its associated objects. Additionally, adaptive weighting may assign higher weights to particles that have consistent states over time, thereby allowing the tracking system to adapt to changing tracklet conditions over time and/or maintain robustness in challenging tracking scenarios. Thus, the adaptive particle resampling and weighting strategies used by the SMC method may help to improve the accuracy and/or efficiency of the SMC method (e.g., the particle filter) when updating the state of a clustered tracklet, especially in complex and/or dynamic scenarios.

In certain aspects, predictions(s) 134, such as trajectory prediction(s) for one or more objects in the scene, may be used for control 136. For example, an agent (not shown), which is an element or entity of, or in communication with, the tracking system, may utilize the prediction(s) 134 output by workflow 100. The agent may be an autonomous vehicle, a robot, a device, or any other intelligent system that leverages the prediction(s) 134, such as for navigation and/or decision-making. For example, where the agent is an autonomous vehicle, then the agent may use the trajectory prediction 134 for one or more objects (e.g., such as a long object or a group objects) in the scene to navigate in its environment. As another example, if the agent is a robot, then the agent may use the trajectory prediction 134 for one or more objects (e.g., such as a long object or a group objects) in the scene to select the best path to take in the scene, such as based on its current goals, and execute this selection.

### Example Graph-Based Approach for Object Tracking

FIGS. 2A-2B depict an example graph 204 construction for tracklets and clustered tracklet generation. More specifically, graph 204 may be constructed in FIG. 2A to generate multiple tracklets 210 for objects detected in a scene. Further, in FIG. 2B, graph 204, with the generated tracklets 210, may be used to generate one or more clustered tracklets.

As shown in FIG. 2A, a set of frames 202, including at least a first frame 202-1 associated with a timestamp t=0, may be used to generate graph 204. In this example, the set of frames 202 may include three objects, as in depictions of three objects (e.g., object 1 (O1), object 2 (O2), and object 3 (O3). Further, in this example, object 1 may be a first cyclist, object 2 may be a second cyclist, and object 3 may be a third cyclist riding together in a scene.

Object detection may be performed for the set of frames 202 to identify twelve detections (e.g., bounding boxe(es), point(s), cluster(s), and/or the like) in the set of frames 202 associated with the three objects (e.g., three objects detected in each of four frames, resulting in 3*4=12 detections). Each of the twelve detections identified in the set of frames 202 may be associated with a single object (e.g., either object 1, object 2, or object 3) and further may be associated with one or more object states for the particular object. For example, a first detection identified in frame 202-1, may include a detection associated with the first object (e.g., the first cyclist). The detection may include information about a location, a velocity, a heading, etc. for the first object.

Based on identifying twelve detections in the set of frames 202, twelve nodes 206 may be added to graph 204. Each node 206 may be associated with one of the detections. For example, a first node 206-1 may be associated with the detection identified in frame 202-1, associated with time t=0. As such, the first node 206-1 may be associated with the first object (O1) (e.g., the first cyclist), and may include information about a state of the first object at time t=0 (e.g., a location, a velocity, a heading, etc. for the first object).

A candidate tracklet edge 208 may be added between each pair of nodes 206, which are associated with different frames. For example, a candidate tracklet edge 208 may be added between first node 206-1, associated with frame 1 (F1), and each node 206 associated with frame 2 (F2) and frame 3 (F3). However, a candidate tracklet edge 208 may not be added between first node 206-1 and each other node 206 in graph 204 associated with frame 1 (F1). It is noted that only candidate tracklet edges for first node 206-1 are shown in FIG. 2A for better visibility of the candidate tracklet edges 208. However, for graph 204 construction, candidate tracklet edges 208 may be added for each of the other nodes 206, as well.

Tracklet generation may include evaluating a similarity of common state(s) associated with each pair of nodes 206, connected via a candidate tracklet edge 208 in FIG. 2A. This evaluation may produce a plurality of hypotheses indicating a similarity of the nodes 206 to one another to create tracklets 210.

In this example, based on the evaluation, nodes 206 in the first row may be determined to be associated with a same object (e.g., the first object (O1)) over the set of frames 202; thus, a first tracklet 210-1 may be created to associate the nodes 206 in the first row, as shown in FIG. 2B. Further, based on the evaluation, nodes 206 in the second row may be determined to be associated with a same object (e.g., the second object (O2)) over the set of frames 202; thus, a second tracklet 210-2 may be created to associate the nodes 206 in the second row, as shown in FIG. 2B. Lastly, based on the evaluation, nodes 206 in the third row may be determined to be associated with a same object (e.g., the third object (O3)) over the set of frames 202; thus, a third tracklet 210-3 may be created to associate the nodes 206 in the third row, as shown in FIG. 2B.

In FIG. 2B, after tracklets 210 are added to graph 204, clustered tracklet generation may be performed to cluster two or more tracklets 210 into one or more clustered tracklets. Put differently, clustered tracklet generation may include determining an association between two or more tracklets 210 to determine if the two or more tracklets are likely to form a coherent tracklet.

To determine which tracklets 210 are associated (if any), candidate clustered tracklet edges 218 may be added to graph 204. Candidate clustered tracklet edges 218 may be added between node pairs including nodes 206 that belong to different tracklets 210 and that are associated with the same frame (e.g., associated with a same timestamp). For example, a candidate clustered tracklet edge 218 is added to graph 204 between each pair of nodes 206 that are associated with frame 1 (F1) and belong to different tracklets 210 (e.g., belong to tracklet 210-1, tracklet 210-2, or tracklet 210-3).

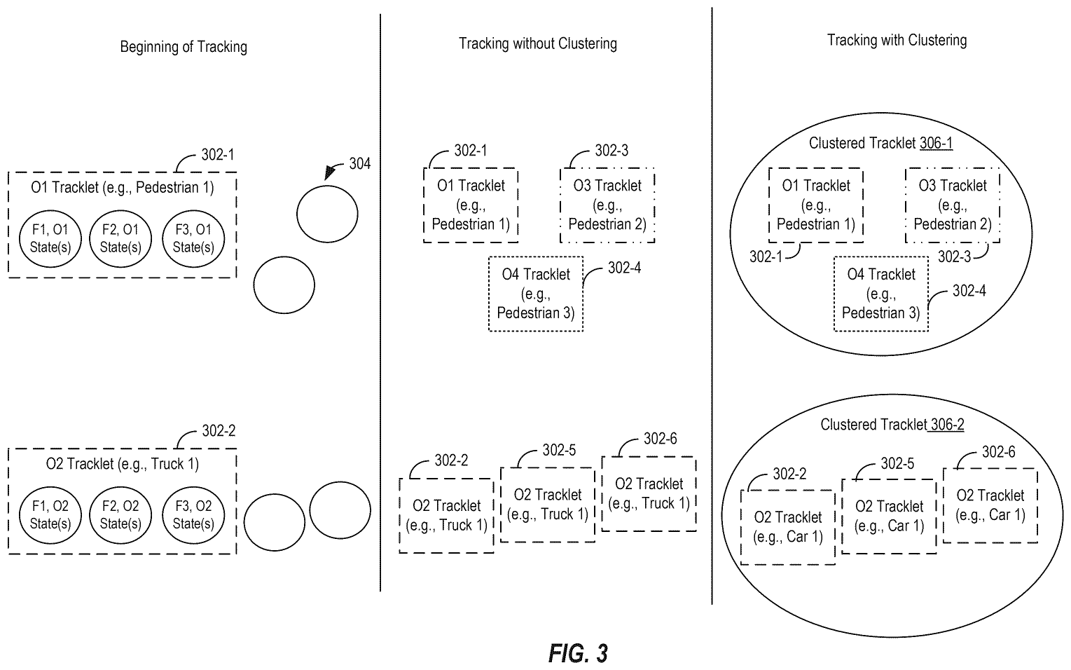

Similar to performing node association in tracklet 210 generation, tracklet 210 association (e.g., to generate one or more clustered tracklets) may include evaluating a similarity of common state(s) associated with each group of tracklets 210, connected via one or more candidate clustered tracklet edges 218 in FIG. 2B. This evaluation may produce a plurality of hypotheses indicating a similarity of the tracklets 210 to one another to create clustered tracklets 220. Example clustered tracklets 220 that may be generated are depicted and described with respect to FIG. 3.

### Example Clustered Tracklets Generation for a Group of Objects and a Long Object

FIG. 3 depicts example clustered tracklets 306 generated for a group of objects and a long object. In this example, the group of objects may include three objects (e.g. a first object (O1), a third object (O3), and a fourth object (O4)) representing three pedestrians (e.g., pedestrian 1, pedestrian 2, and pedestrian 3) in a scene. Further, in this example, the long object may be a second object (O2) in the scene (e.g., truck 1).

As shown, at the first stages of tracking objects in the scene, a first tracklet 302-1 may be created for O1 (e.g., pedestrian 1) based on detections identified for O1 in a first set of three frames (e.g., frame 1 (F1), frame 2 (F2), and frame 3 (F3)). Further, a second tracklet 302-2 may be created for O2 (e.g., truck 1) based on detections identified for O2 in the first set of three frames. Other detections 304 may also be identified in a second set of frames.

These detections 304 may result in the creation of a third tracklet 302-3 for O3 (e.g., pedestrian 2), a fourth tracklet 302-4 for O3 (e.g., pedestrian 3), a fifth tracklet for O2 (e.g., truck 1), and a sixth tracklet for O2 (e.g., truck 1). For example, the detections 304 and states associated with O2 (e.g., truck 1) may be fragmented into three tracklets 302-2, 302-5, and 302-6, such as corresponding to different parts of the truck.

In certain aspects, based on determining the association between tracklets 302-1, 302-3, and 302-4, the tracking system may determine that tracklets 302-1, 302-3, and 302-4 form a coherent tracklet. Thus, a clustered tracklet 306-1 may be created to include tracklets 302-1, 302-3, and 302-4. Clustered tracklet 306-1 may be used to predict a trajectory for each of pedestrian 1, pedestrian 2, and pedestrian 3.

Similarly, based on determining the association between tracklets 302-2, 302-5, and 302-6, the tracking system may determine that tracklets 302-2, 302-5, and 302-6 form a coherent tracklet. Thus, a clustered tracklet 306-2 may be created to include tracklets 302-2, 302-5, and 302-6. Clustered tracklet 306-2 may be used to predict a trajectory for truck 1 (instead of predicting a trajectory for truck 1 using three different, fragmented tracklets 302).

### Example Methods for Object Tracking

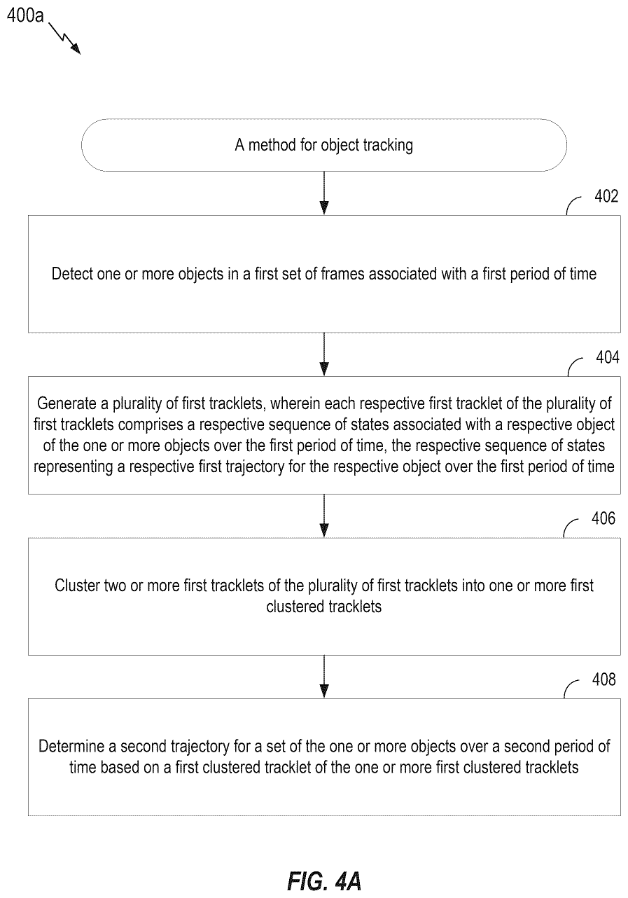

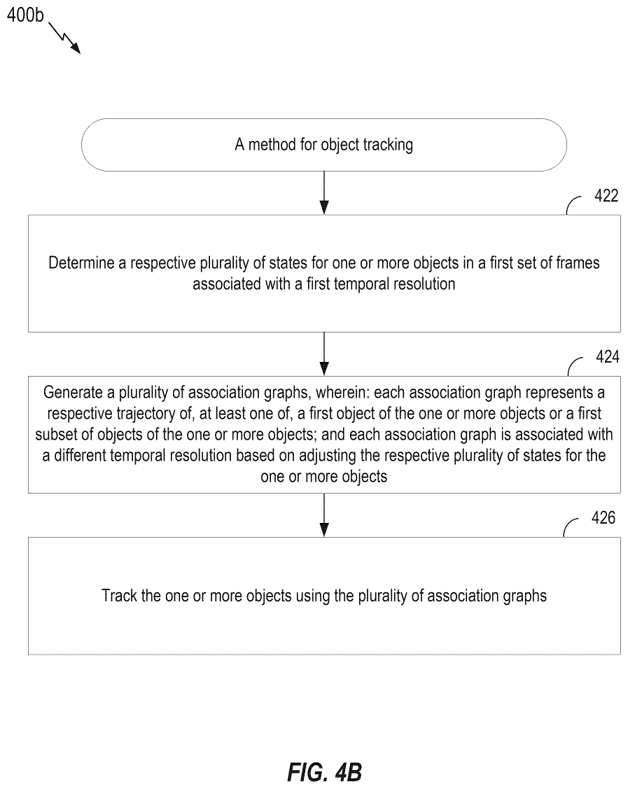

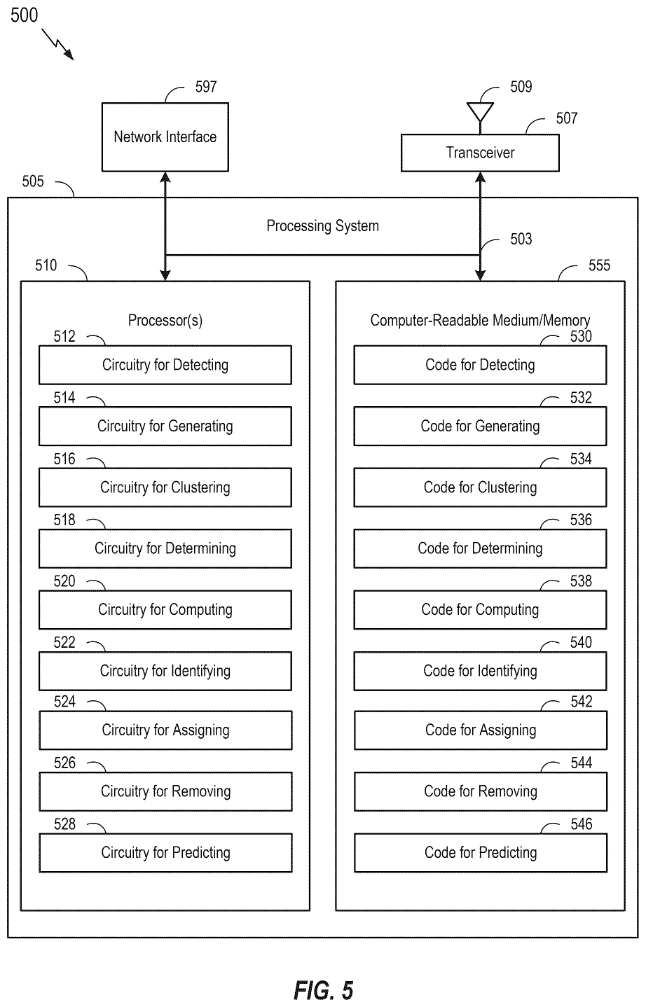

FIG. 4A depicts an example method 400a for object tracking. In certain aspects, method 400a, or any aspect related to it, may be performed by an apparatus, such as device 500 of FIG. 5, which includes various components operable, configured, or adapted to perform the method 400a.

Method 400a begins a block 402 with detecting one or more objects in a first set of frames associated with a first period of time.

Method 400a proceeds at block 404 with generating a plurality of first tracklets. Each respective first tracklet of the plurality of first tracklets may include a respective sequence of states associated with a respective object of the one or more objects over the first period of time. The respective sequence of states may represent a respective first trajectory for the respective object over the first period of time.

Method 400a proceeds at block 406 with clustering two or more first tracklets of the plurality of first tracklets into one or more first clustered tracklets. In certain aspects, clustering the two or more first tracklets is based on: the respective sequence of states associated with each respective first tracklet of the two or more first tracklets; and one or more similarity criteria

Method 400a proceeds at block 408 with determining a second trajectory for a set of the one or more objects over a second period of time based on a first clustered tracklet of the one or more first clustered tracklets. The first clustered tracklet may include a set of the plurality of first tracklets associated with the set of the one or more objects.

Note that FIG. 4A is just one example of a method, and other methods including fewer, additional, or alternative steps are possible consistent with this disclosure.

In certain aspects, the one or more similarity criteria comprise a plurality of similarity criteria; and clustering the two or more first tracklets into the one or more first clustered tracklets comprises clustering the two or more first tracklets into a plurality of first clustered tracklets based on the plurality of similarity criteria.

In certain aspects, clustering the two or more first tracklets into the one or more first clustered tracklets comprises: determining a first likelihood that each respective first tracklet of the two or more first tracklets together form a coherent tracklet based on the respective sequence of states associated with each respective first tracklet of the two or more first tracklets; determining a second likelihood that each respective first tracklet of the two or more first tracklets together do not form the coherent tracklet based on the respective sequence of states associated with each respective first tracklet of the two or more first tracklets; computing a likelihood ratio test statistic based on a ratio of the first likelihood to the second likelihood; and clustering the two or more first tracklets into a first clustered tracklet of the one or more of first clustered tracklets based on the likelihood ratio test statistic and a likelihood ratio test threshold based on a first similarity criteria of the one or more similarity criteria.

In certain aspects, determining the first likelihood that each respective first tracklet of the two or more first tracklets together form the coherent tracklet comprises: identifying one or more common states among the respective sequence of states associated with each respective first tracklet of the two or more first tracklets; assigning a weight to each respective common state among the one or more common states associated with each respective first tracklet of the two or more first tracklets based on one or more factors; and determining the first likelihood based on the weighted one or more common states.

In certain aspects, determining the second likelihood that each respective first tracklet of the two or more first tracklets together do not form the coherent tracklet comprises: identifying one or more common states among the respective sequence of states associated with each respective first tracklet of the two or more first tracklets; assigning a weight to each respective common state among the one or more common states associated with each respective first tracklet of the two or more first tracklets based on one or more factors; and determining the second likelihood based on the weighted one or more common states.

In certain aspects, detecting the one or more objects comprises detecting the one or more objects as a plurality of detections, each respective detection of the plurality of detections being associated with a respective object and one or more states of the respective object at a respective first timestamp within the first period of time; and generating the plurality of first tracklets comprises: for one or more respective pairs of detections comprising two respective detections of the plurality of detections: determining a first likelihood that each respective detection of the two respective detections are associated; determining a second likelihood that each respective detection of the two respective detections are not associated; computing a likelihood ratio test statistic based on a ratio of the first likelihood to the second likelihood; and generating a first tracklet of the plurality of first tracklets based on the likelihood ratio test statistic and a likelihood ratio test threshold based on a first similarity criteria of the one or more similarity criteria.

In certain aspects, determining the first likelihood that each respective detection of the two respective detections are associated comprises: identifying one or more common states among the two respective detections; assigning a weight to each respective common state among the one or more common states associated with each respective detection of the two the two respective detections based on one or more factors; and determining the first likelihood based on the weighted one or more common states.

In certain aspects, determining the second likelihood that each respective detection of the two respective detections are not associated comprises: identifying one or more common states among the two respective detections; assigning a weight to each respective common state among the one or more common states associated with each respective detection of the two the two respective detections based on one or more factors; and determining the second likelihood based on the weighted one or more common states.

In certain aspects, detecting the one or more objects comprises detecting the one or more objects as a plurality of first detections, each respective first detection of the plurality of first detections being associated with a respective object at a respective first timestamp within the first period of time; and the method further comprises generating a graph comprising: a plurality of first nodes representing the plurality of first detections; and a plurality of first edges, wherein each respective first node of the plurality of first nodes is associated with a respective first detection of the plurality of first detections, and wherein each respective first edge connects two first nodes of the plurality of first nodes associated with a same first timestamp and associated with different first tracklets; and clustering the two or more first tracklets into the one or more first clustered tracklets comprises clustering the two or more first tracklets into the one or more first clustered tracklets based on the graph.

In certain aspects, generating the graph comprising the plurality of first nodes and the plurality of first edges comprises: generating a respective first node for each respective first detection of the plurality of first detections to create the plurality of first nodes, wherein each respective first node represents one or more respective states associated with the respective first detection; generating a respective second edge between each respective pair of first nodes associated with the same first timestamp and associated with the different first tracklets to create a plurality of second edges; assigning a respective weight to each respective second edge based on at least one respective state of the one or more respective states associated with each respective first node of the respective pair of first nodes; and removing at least one second edge of the plurality of second edges based on the respective weight assigned to the at least one second edge, wherein the plurality of first edges comprises the plurality of second edges after the removal.

In certain aspects, clustering the two or more first tracklets into the one or more first clustered tracklets comprises: generating a respective hypothesis for each respective combination of first tracklets associated with first nodes connected via one or more second edges of the plurality of second edges to create a plurality of hypotheses, the respective hypothesis indicating a likelihood that the respective combination of first tracklets form a coherent tracklet; and clustering the two or more first tracklets based on the plurality of hypotheses.

In certain aspects, the one or more respective states associated with each respective detection comprise at least one of: a size of a respective object associated with the respective detection; a location of the respective object in a scene; an orientation of the respective object; a pose estimation of the respective object; one or more shape descriptors associated with the respective object; one or more visual features of the respective object; a velocity of the respective object; an acceleration of the respective object; a heading of the respective object; a semantic class associated with the respective object; a semantic class confidence score; a trajectory score associated with the respective object; one or more confidence scores; a trajectory standard deviation; time elapsed since a last detection of the respective object; one or more dynamics of the scene; an occlusion state of the respective object; one or more interaction features; an environmental context; an appearance change rate; a measure of a consistency of the respective object; a tracking history of the respective object; a predicted future position of the respective object; a sensor modality confidence score; scene flow information; or optical flow information.

In certain aspects, assigning the respective weight to each respective second edge comprises: assigning a first respective weight to each respective second edge based on the at least one respective state associated with each respective first node having a similarity that satisfies a threshold similarity; and assigning a second respective weight to each respective second edge based on the at least one respective state associated with each respective first node having the similarity that does not satisfy the threshold similarity, the first respective weight being greater than the second respective weight.

In certain aspects, generating the graph comprising the plurality of first nodes and the plurality of first edges comprises: generating a respective first node for each respective first detection of the plurality of first detections to create the plurality of first nodes, wherein each respective first node represents one or more respective states associated with the respective first detection; generating a respective second edge between each respective pair of first nodes associated with the same first timestamp and associated with the different first tracklets to create a plurality of second edges; and removing at least one second edge of the plurality of second edges based on the respective pair of first nodes associated with the at least one second edge being associated with at least one of: different objects among the one or more objects; or locations that are a first distance apart, the first distance satisfying a distance threshold, wherein the plurality of first edges comprises the plurality of second edges after the removal.

In certain aspects, clustering the two or more first tracklets into the one or more first clustered tracklets comprises: generating a respective hypothesis for each respective combination of first tracklets associated with first nodes connected via one or more second edges of the plurality of second edges to create a plurality of hypotheses, the respective hypothesis indicating a likelihood that the respective combination of first tracklets form a coherent tracklet; and clustering the two or more first tracklets based on the plurality of hypotheses.

In certain aspects, the graph further comprises a plurality of second edges, wherein each respective second edge connects two first nodes of the plurality of first nodes associated with different first timestamps; and generating the plurality of first tracklets comprises generating the plurality of first tracklets based on the graph.

In certain aspects, generating the graph comprising the plurality of first nodes and the plurality of second edges comprises: generating a respective first node for each respective first detection of the plurality of first detections to create the plurality of first nodes, wherein each respective first node represents one or more respective states associated with the respective first detection; generating a respective third edge between each respective pair of first nodes associated with different first timestamps to create a plurality of third edges in the graph; assigning a respective weight to each respective third edge based on at least one respective state of the one or more respective states associated with each respective first node of the respective pair of first nodes; and removing at least one third edge of the plurality of third edges based on the respective weight assigned to the at least one third edge, wherein the plurality of second edges comprises the plurality of third edges after the removal.

In certain aspects, generating the plurality of first tracklets comprises: generating a respective hypothesis for each respective pair of first nodes connected via a second edge of the plurality of second edges, each respective hypothesis indicating a likelihood that the respective pair of first nodes are associated; and generating at least one first tracklet for at least one respective pair of first nodes based on the respective hypothesis associated with the respective pair of first nodes.

In certain aspects, the one or more respective states associated with each respective detection comprise at least one of: a size of a respective object associated with the respective detection; a location of the respective object in a scene; an orientation of the respective object; a pose estimation of the respective object; one or more shape descriptors associated with the respective object; one or more visual features of the respective object; a velocity of the respective object; an acceleration of the respective object; a heading of the respective object; a semantic class associated with the respective object; a semantic class confidence score; a trajectory score associated with the respective object; one or more confidence scores; a trajectory standard deviation; time elapsed since a last detection of the respective object; one or more dynamics of the scene; an occlusion state of the respective object; one or more interaction features; an environmental context; an appearance change rate; a measure of a consistency of the respective object; a tracking history of the respective object; a predicted future position of the respective object; a sensor modality confidence score; scene flow information; or optical flow information.

In certain aspects, assigning the respective weight to each respective third edge comprises: assigning a first respective weight to each respective third edge based on the at least one respective state associated with each respective first node having a similarity that satisfies a threshold similarity; and assigning a second respective weight to each respective second edge based on the at least one respective state associated with each respective first node having the similarity that does not satisfy the threshold similarity, the first respective weight being greater than the second respective weight.

In certain aspects, generating the graph comprising the plurality of first nodes and the plurality of second edges comprises: generating a respective first node for each respective first detection of the plurality of first detections to create the plurality of first nodes, wherein each respective first node represents one or more respective states associated with the respective first detection; generating a respective third edge between each respective pair of first nodes associated with different first timestamps to create a plurality of third edges; and removing at least one third edge of the plurality of second edges based on the respective pair of first nodes associated with the at least one third edge being associated with at least one of: different objects among the one or more objects; or locations that are a first distance apart, the first distance satisfying a distance threshold, wherein the plurality of second edges comprises the plurality of third edges after the removal.

In certain aspects, the first set of frames and the graph are associated with a first temporal resolution; and the method further comprises adjusting the graph to have a second temporal resolution that is smaller than or larger than the first temporal resolution.

In certain aspects, determining the second trajectory for the set of the one or more objects over the second period of time based on the first clustered tracklet comprises: predicting a regular motion of the set of the one or more objects based on one or more deterministic motion equations; predicting one or more probabilistic maneuvers of the set of the one or more objects; and determining one or more future states associated with the set of the one or more objects based on the regular motion and the one or more probabilistic maneuvers.

In certain aspects, determining the second trajectory for the set of the one or more objects over the second period of time based on the first clustered tracklet comprises determining the second trajectory using a sequential Monte Carlo method.

In certain aspects, each respective sequence of states associated with each respective object and each respective first tracklet comprises at least one of: a size of the respective object; a location of the respective object in a scene; an orientation of the respective object; a pose estimation of the respective object; one or more shape descriptors associated with the respective object; one or more visual features of the respective object; a velocity of the respective object; an acceleration of the respective object; a heading of the respective object; a semantic class associated with the respective object; a semantic class confidence score; a trajectory score associated with the respective object; one or more confidence scores; a trajectory standard deviation; time elapsed since a last detection of the respective object; one or more dynamics of the scene; an occlusion state of the respective object; one or more interaction features; an environmental context; an appearance change rate; a measure of a consistency of the respective object; a tracking history of the respective object; a predicted future position of the respective object; a sensor modality confidence score; scene flow information; or optical flow information.

FIG. 4B depicts another example method 400b for object tracking. In certain aspects, method 400b, or any aspect related to it, may be performed by an apparatus, such as device 500 of FIG. 5, which includes various components operable, configured, or adapted to perform the method 400b.

Method 400b begins a block 422 with determining a respective plurality of states for one or more objects in a first set of frames associated with a first temporal resolution.

Method 400b proceeds at block 424 with generating a plurality of association graphs, wherein: each association graph represents a respective trajectory of, at least one of, a first object of the one or more objects or a first subset of objects of the one or more objects; and each association graph is associated with a different temporal resolution based on adjusting the respective plurality of states for the one or more objects.

Method 400b proceeds at block 426 with tracking the one or more objects using the plurality of association graphs.

In certain aspects, generating the plurality of association graphs comprises: generating a first association graph associated with a second temporal resolution that is less than the first temporal resolution; and generating a second association graph associated with a third temporal resolution that is greater than the first temporal resolution.

In certain aspects, generating the first association graph comprises predicting one or more intermediate states of the one or more objects between at least two frames in the first set of frames.

In certain aspects, generating the second association graph comprises aggregating at least two of states of the respective plurality of states associated with a respective object of the one or more objects.

In certain aspects, a first association graph of the plurality of association graphs represents a first trajectory of the first object based on associating two or more of the respective plurality of states associated with the first object.

In certain aspects, a first association graph of the plurality of association graphs represents a first trajectory of the first subset of objects based on associating two or more of the respective plurality of states associated with the first subject of objects.

Note that FIG. 4B is just one example of a method, and other methods including fewer, additional, or alternative steps are possible consistent with this disclosure.

### Example Device for Object Tracking

FIG. 5 depicts aspects of an example device 500 configured to perform object tracking, such as based on clustering of tracklets.

Device 500 includes a processing system 505. In certain aspects, processing system 505 may be coupled to a transceiver 507 (e.g., a transmitter and/or a receiver) and/or a network interface 597. The transceiver 507 may be configured to transmit and receive signals for the device 500 via an antenna 509, such as the various signals as described herein. The network interface 597 may be configured to obtain and send signals for the device 500 via communications link(s).

The processing system 505 includes one or more processors 510. The one or more processors 510 are coupled to a computer-readable medium/memory 555 via a bus 503. In certain aspects, the computer-readable medium/memory 555 is configured to store instructions (e.g., computer-executable code), including code 560-585, that when executed by the one or more processors 510, enable and cause the one or more processors 510 to perform the method 400a described with respect to FIG. 4A, perform the method 400b described with respect to FIG. 4B, and/or any aspect related to methods 400a, 400b, including any operations described in relation to FIG. 1. Note that reference to a processor of device 500 performing a function may include one or more processors of device 500 performing that function, such as in a distributed fashion.

In the depicted example, the computer-readable medium/memory 555 stores code 530 for detecting, code 532 for generating, code 534 for clustering, code 536 for determining, code 538 for computing, code 540 for identifying, code 542 for assigning, code 544 for removing, and code 546 for predicting. Processing of the code 530-546 may enable and cause the device 500 to perform the method 400a described with respect to FIG. 4A, perform the method 400b described with respect to FIG. 4B, and/or any aspect related to methods 400a, 400b.

The one or more processors 510 include circuitry configured to implement (e.g., execute) the code (e.g., executable instructions) stored in the computer-readable medium/memory 555, including circuitry 512 for detecting, circuitry 514 for generating, circuitry 516 for clustering, circuitry 518 for determining, circuitry 520 for computing, circuitry 522 for identifying, circuitry 524 for assigning, circuitry 526 for removing, and circuitry 528 for predicting. Processing with circuitry 512-528 may enable and cause the device 500 to perform the method 400a described with respect to FIG. 4A, perform the method 400b described with respect to FIG. 4B, and/or any aspect related to methods 400a, 400b.

Various components of the device 500 may provide means for performing the method 400a described with respect to FIG. 4A, perform the method 400b described with respect to FIG. 4B, and/or any aspect related to methods 400a, 400b. For example, means for obtaining, processing, generating, initializing, determining, and/or modify of the method 400a described with respect to FIG. 4A, perform the method 400b described with respect to FIG. 4B, and/or any aspect related to methods 400a, 400b may include one or more processors 510 of the device 500 in FIG. 5.

### EXAMPLE CLAUSES

Implementation examples are described in the following numbered clauses:

Clause 1: A method for object tracking, comprising: detecting one or more objects in a first set of frames associated with a first period of time; generating a plurality of first tracklets, wherein each respective first tracklet of the plurality of first tracklets comprises a respective sequence of states associated with a respective object of the one or more objects over the first period of time, the respective sequence of states representing a respective first trajectory for the respective object over the first period of time; clustering two or more first tracklets of the plurality of first tracklets into one or more first clustered tracklets; and determining a second trajectory for a set of the one or more objects over a second period of time based on a first clustered tracklet of the one or more first clustered tracklets.

Clause 2: The method of Clause 1, wherein the first clustered tracklet comprises a set of the plurality of first tracklets associated with the set of the one or more objects.

Clause 3: The method of any one of Clauses 1-2, wherein clustering the two or more first tracklets into the one or more first clustered tracklets comprises clustering the two or more first tracklets into the one or more first clustered tracklets based on: the respective sequence of states associated with each respective first tracklet of the two or more first tracklets; and one or more similarity criteria

Clause 4: The method of Clause 3, wherein: the one or more similarity criteria comprise a plurality of similarity criteria; and clustering the two or more first tracklets into the one or more first clustered tracklets comprises clustering the two or more first tracklets into a plurality of first clustered tracklets based on the plurality of similarity criteria.

Clause 5: The method of any one of Clauses 3-4, wherein clustering the two or more first tracklets into the one or more first clustered tracklets comprises: determining a first likelihood that each respective first tracklet of the two or more first tracklets together form a coherent tracklet based on the respective sequence of states associated with each respective first tracklet of the two or more first tracklets; determining a second likelihood that each respective first tracklet of the two or more first tracklets together do not form the coherent tracklet based on the respective sequence of states associated with each respective first tracklet of the two or more first tracklets; computing a likelihood ratio test statistic based on a ratio of the first likelihood to the second likelihood; and clustering the two or more first tracklets into a first clustered tracklet of the one or more of first clustered tracklets based on the likelihood ratio test statistic and a likelihood ratio test threshold based on a first similarity criteria of the one or more similarity criteria.

Clause 6: The method of Clause 5, wherein determining the first likelihood that each respective first tracklet of the two or more first tracklets together form the coherent tracklet comprises: identifying one or more common states among the respective sequence of states associated with each respective first tracklet of the two or more first tracklets; assigning a weight to each respective common state among the one or more common states associated with each respective first tracklet of the two or more first tracklets based on one or more factors; and determining the first likelihood based on the weighted one or more common states.

Clause 7: The method of any one of Clauses 5-6, wherein determining the second likelihood that each respective first tracklet of the two or more first tracklets together do not form the coherent tracklet comprises: identifying one or more common states among the respective sequence of states associated with each respective first tracklet of the two or more first tracklets; assigning a weight to each respective common state among the one or more common states associated with each respective first tracklet of the two or more first tracklets based on one or more factors; and determining the second likelihood based on the weighted one or more common states.

Clause 8: The method of any one of Clauses 1-7, wherein: detecting the one or more objects comprises detecting the one or more objects as a plurality of detections, each respective detection of the plurality of detections being associated with a respective object and one or more states of the respective object at a respective first timestamp within the first period of time; and generating the plurality of first tracklets comprises: for one or more respective pairs of detections comprising two respective detections of the plurality of detections: determining a first likelihood that each respective detection of the two respective detections are associated; determining a second likelihood that each respective detection of the two respective detections are not associated; computing a likelihood ratio test statistic based on a ratio of the first likelihood to the second likelihood; and generating a first tracklet of the plurality of first tracklets based on the likelihood ratio test statistic and a likelihood ratio test threshold based on a first similarity criteria of the one or more similarity criteria.

Clause 9: The method of Clause 8, wherein determining the first likelihood that each respective detection of the two respective detections are associated comprises: identifying one or more common states among the two respective detections; assigning a weight to each respective common state among the one or more common states associated with each respective detection of the two the two respective detections based on one or more factors; and determining the first likelihood based on the weighted one or more common states.

Clause 10: The method of any one of Clauses 8-9, wherein determining the second likelihood that each respective detection of the two respective detections are not associated comprises: identifying one or more common states among the two respective detections; assigning a weight to each respective common state among the one or more common states associated with each respective detection of the two the two respective detections based on one or more factors; and determining the second likelihood based on the weighted one or more common states.

Clause 11: The method of any one of Clauses 1-10, wherein: detecting the one or more objects comprises detecting the one or more objects as a plurality of first detections, each respective first detection of the plurality of first detections being associated with a respective object at a respective first timestamp within the first period of time; and the method further comprises generating a graph comprising: a plurality of first nodes representing the plurality of first detections; and a plurality of first edges, wherein each respective first node of the plurality of first nodes is associated with a respective first detection of the plurality of first detections, and wherein each respective first edge connects two first nodes of the plurality of first nodes associated with a same first timestamp and associated with different first tracklets; and clustering the two or more first tracklets into the one or more first clustered tracklets comprises clustering the two or more first tracklets into the one or more first clustered tracklets based on the graph.

Clause 12: The method of Clause 11, wherein generating the graph comprising the plurality of first nodes and the plurality of first edges comprises: generating a respective first node for each respective first detection of the plurality of first detections to create the plurality of first nodes, wherein each respective first node represents one or more respective states associated with the respective first detection; generating a respective second edge between each respective pair of first nodes associated with the same first timestamp and associated with the different first tracklets to create a plurality of second edges; assigning a respective weight to each respective second edge based on at least one respective state of the one or more respective states associated with each respective first node of the respective pair of first nodes; and removing at least one second edge of the plurality of second edges based on the respective weight assigned to the at least one second edge, wherein the plurality of first edges comprises the plurality of second edges after the removal.

Clause 13: The method of Clause 12, wherein clustering the two or more first tracklets into the one or more first clustered tracklets comprises: generating a respective hypothesis for each respective combination of first tracklets associated with first nodes connected via one or more second edges of the plurality of second edges to create a plurality of hypotheses, the respective hypothesis indicating a likelihood that the respective combination of first tracklets form a coherent tracklet; and clustering the two or more first tracklets based on the plurality of hypotheses.

Clause 14: The method of any one of Clauses 12-13, wherein the one or more respective states associated with each respective detection comprise at least one of: a size of a respective object associated with the respective detection; a location of the respective object in a scene; an orientation of the respective object; a pose estimation of the respective object; one or more shape descriptors associated with the respective object; one or more visual features of the respective object; a velocity of the respective object; an acceleration of the respective object; a heading of the respective object; a semantic class associated with the respective object; a semantic class confidence score; a trajectory score associated with the respective object; one or more confidence scores; a trajectory standard deviation; time elapsed since a last detection of the respective object; one or more dynamics of the scene; an occlusion state of the respective object; one or more interaction features; an environmental context; an appearance change rate; a measure of a consistency of the respective object; a tracking history of the respective object; a predicted future position of the respective object; a sensor modality confidence score; scene flow information; or optical flow information.

Clause 15: The method of any one of Clauses 12-13, wherein assigning the respective weight to each respective second edge comprises: assigning a first respective weight to each respective second edge based on the at least one respective state associated with each respective first node having a similarity that satisfies a threshold similarity; and assigning a second respective weight to each respective second edge based on the at least one respective state associated with each respective first node having the similarity that does not satisfy the threshold similarity, the first respective weight being greater than the second respective weight.

Clause 16: The method of any one of Clauses 11-15, wherein generating the graph comprising the plurality of first nodes and the plurality of first edges comprises: generating a respective first node for each respective first detection of the plurality of first detections to create the plurality of first nodes, wherein each respective first node represents one or more respective states associated with the respective first detection; generating a respective second edge between each respective pair of first nodes associated with the same first timestamp and associated with the different first tracklets to create a plurality of second edges; and removing at least one second edge of the plurality of second edges based on the respective pair of first nodes associated with the at least one second edge being associated with at least one of: different objects among the one or more objects; or locations that are a first distance apart, the first distance satisfying a distance threshold, wherein the plurality of first edges comprises the plurality of second edges after the removal.

Clause 17: The method of Clause 16, wherein clustering the two or more first tracklets into the one or more first clustered tracklets comprises: generating a respective hypothesis for each respective combination of first tracklets associated with first nodes connected via one or more second edges of the plurality of second edges to create a plurality of hypotheses, the respective hypothesis indicating a likelihood that the respective combination of first tracklets form a coherent tracklet; and clustering the two or more first tracklets based on the plurality of hypotheses.

Clause 18: The method of any one of Clauses 11-17, wherein: the graph further comprises a plurality of second edges, wherein each respective second edge connects two first nodes of the plurality of first nodes associated with different first timestamps; and generating the plurality of first tracklets comprises generating the plurality of first tracklets based on the graph.

Clause 19: The method of Clause 18, wherein generating the graph comprising the plurality of first nodes and the plurality of second edges comprises: generating a respective first node for each respective first detection of the plurality of first detections to create the plurality of first nodes, wherein each respective first node represents one or more respective states associated with the respective first detection; generating a respective third edge between each respective pair of first nodes associated with different first timestamps to create a plurality of third edges in the graph; assigning a respective weight to each respective third edge based on at least one respective state of the one or more respective states associated with each respective first node of the respective pair of first nodes; and removing at least one third edge of the plurality of third edges based on the respective weight assigned to the at least one third edge, wherein the plurality of second edges comprises the plurality of third edges after the removal.

Clause 20: The method of Clause 19, wherein generating the plurality of first tracklets comprises: generating a respective hypothesis for each respective pair of first nodes connected via a second edge of the plurality of second edges, each respective hypothesis indicating a likelihood that the respective pair of first nodes are associated; and generating at least one first tracklet for at least one respective pair of first nodes based on the respective hypothesis associated with the respective pair of first nodes.

Clause 21: The method of any one of Clauses 19-20, wherein the one or more respective states associated with each respective detection comprise at least one of: a size of a respective object associated with the respective detection; a location of the respective object in a scene; an orientation of the respective object; a pose estimation of the respective object; one or more shape descriptors associated with the respective object; one or more visual features of the respective object; a velocity of the respective object; an acceleration of the respective object; a heading of the respective object; a semantic class associated with the respective object; a semantic class confidence score; a trajectory score associated with the respective object; one or more confidence scores; a trajectory standard deviation; time elapsed since a last detection of the respective object; one or more dynamics of the scene; an occlusion state of the respective object; one or more interaction features; an environmental context; an appearance change rate; a measure of a consistency of the respective object; a tracking history of the respective object; a predicted future position of the respective object; a sensor modality confidence score; scene flow information; or optical flow information.

Clause 22: The method of any one of Clauses 19-21, wherein assigning the respective weight to each respective third edge comprises: assigning a first respective weight to each respective third edge based on the at least one respective state associated with each respective first node having a similarity that satisfies a threshold similarity; and assigning a second respective weight to each respective second edge based on the at least one respective state associated with each respective first node having the similarity that does not satisfy the threshold similarity, the first respective weight being greater than the second respective weight.

Clause 23: The method of any one of Clauses 18-22, wherein generating the graph comprising the plurality of first nodes and the plurality of second edges comprises: generating a respective first node for each respective first detection of the plurality of first detections to create the plurality of first nodes, wherein each respective first node represents one or more respective states associated with the respective first detection; generating a respective third edge between each respective pair of first nodes associated with different first timestamps to create a plurality of third edges; and removing at least one third edge of the plurality of second edges based on the respective pair of first nodes associated with the at least one third edge being associated with at least one of: different objects among the one or more objects; or locations that are a first distance apart, the first distance satisfying a distance threshold, wherein the plurality of second edges comprises the plurality of third edges after the removal.

Clause 24: The method of any one of Clauses 11-23, wherein: the first set of frames and the graph are associated with a first temporal resolution; and the method further comprises adjusting the graph to have a second temporal resolution that is smaller than or larger than the first temporal resolution.

Clause 25: The method of any one of Clauses 1-24, wherein determining the second trajectory for the set of the one or more objects over the second period of time based on the first clustered tracklet comprises: predicting a regular motion of the set of the one or more objects based on one or more deterministic motion equations; predicting one or more probabilistic maneuvers of the set of the one or more objects; and determining one or more future states associated with the set of the one or more objects based on the regular motion and the one or more probabilistic maneuvers.

Clause 26: The method of any one of Clauses 1-25, wherein determining the second trajectory for the set of the one or more objects over the second period of time based on the first clustered tracklet comprises determining the second trajectory using a sequential Monte Carlo method.

Clause 27: The method of any one of Clauses 1-26, wherein each respective sequence of states associated with each respective object and each respective first tracklet comprises at least one of: a size of the respective object; a location of the respective object in a scene; an orientation of the respective object; a pose estimation of the respective object; one or more shape descriptors associated with the respective object; one or more visual features of the respective object; a velocity of the respective object; an acceleration of the respective object; a heading of the respective object; a semantic class associated with the respective object; a semantic class confidence score; a trajectory score associated with the respective object; one or more confidence scores; a trajectory standard deviation; time elapsed since a last detection of the respective object; one or more dynamics of the scene; an occlusion state of the respective object; one or more interaction features; an environmental context; an appearance change rate; a measure of a consistency of the respective object; a tracking history of the respective object; a predicted future position of the respective object; a sensor modality confidence score; scene flow information; or optical flow information.

Clause 28: A method for object tracking, comprising: determining a respective plurality of states for one or more objects in a first set of frames associated with a first temporal resolution; generating a plurality of association graphs, wherein: each association graph represents a respective trajectory of, at least one of, a first object of the one or more objects or a first subset of objects of the one or more objects; and each association graph is associated with a different temporal resolution based on adjusting the respective plurality of states for the one or more objects; and tracking the one or more objects using the plurality of association graphs.

Clause 29: The method of Clause 28, wherein generating the plurality of association graphs comprises: generating a first association graph associated with a second temporal resolution that is less than the first temporal resolution; and generating a second association graph associated with a third temporal resolution that is greater than the first temporal resolution.

Clause 30: The method of Clause 29, wherein generating the first association graph comprises predicting one or more intermediate states of the one or more objects between at least two frames in the first set of frames.

Clause 31: The method of any one of Clauses 29-30, wherein generating the second association graph comprises aggregating at least two of states of the respective plurality of states associated with a respective object of the one or more objects.

Clause 32: The method of any one of Clauses 28-31, wherein a first association graph of the plurality of association graphs represents a first trajectory of the first object based on associating two or more of the respective plurality of states associated with the first object.

Clause 33: The method of any one of Clauses 28-32, wherein a first association graph of the plurality of association graphs represents a first trajectory of the first subset of objects based on associating two or more of the respective plurality of states associated with the first subject of objects.

Clause 34: One or more apparatuses, comprising: one or more memories comprising executable instructions; and one or more processors configured to execute the executable instructions and cause the one or more apparatuses to perform a method in accordance with any one of Clauses 1-33.

Clause 35: One or more apparatuses, comprising: one or more memories; and one or more processors, coupled to the one or more memories, configured to cause the one or more apparatuses to perform a method in accordance with any one of Clauses 1-33.

Clause 36: One or more apparatuses, comprising: one or more memories; and one or more processors, coupled to the one or more memories, configured to perform a method in accordance with any one of Clauses 1-33.

Clause 37: One or more apparatuses, comprising means for performing a method in accordance with any one of Clauses 1-33.

Clause 38: One or more non-transitory computer-readable media comprising executable instructions that, when executed by one or more processors of one or more apparatuses, cause the one or more apparatuses to perform a method in accordance with any one of Clauses 1-33.

Clause 39: One or more computer program products embodied on one or more computer-readable storage media comprising code for performing a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising:
one or more memories; and
one or more processors, coupled to the one or more memories, configured to cause the apparatus to:
detect one or more objects in a first set of frames associated with a first period of time;
generate a plurality of first tracklets, wherein each respective first tracklet of the plurality of first tracklets comprises a respective sequence of states associated with a respective object of the one or more objects over the first period of time, the respective sequence of states representing a respective first trajectory for the respective object over the first period of time;
cluster two or more first tracklets of the plurality of first tracklets into one or more first clustered tracklets; and
determine a second trajectory for a set of the one or more objects over a second period of time based on a first clustered tracklet of the one or more first clustered tracklets.

2. The apparatus of claim 1, wherein the first clustered tracklet comprises a set of the plurality of first tracklets associated with the set of the one or more objects.

3. The apparatus of claim 1, wherein to cluster the two or more first tracklets into the one or more first clustered tracklets, the one or more processors are configured to cause the apparatus to cluster the two or more first tracklets into the one or more first clustered tracklets based on:
the respective sequence of states associated with each respective first tracklet of the two or more first tracklets; and
one or more similarity criteria.

4. The apparatus of claim 3, wherein:
the one or more similarity criteria comprise a plurality of similarity criteria; and
to cluster the two or more first tracklets into the one or more first clustered tracklets, the one or more processors are configured to cause the apparatus to cluster the two or more first tracklets into a plurality of first clustered tracklets based on the plurality of similarity criteria.

5. The apparatus of claim 3, wherein to cluster the two or more first tracklets into the one or more first clustered tracklets, the one or more processors are configured to cause the apparatus to:
determine a first likelihood that each respective first tracklet of the two or more first tracklets together form a coherent tracklet based on the respective sequence of states associated with each respective first tracklet of the two or more first tracklets;
determine a second likelihood that each respective first tracklet of the two or more first tracklets together do not form the coherent tracklet based on the respective sequence of states associated with each respective first tracklet of the two or more first tracklets;
compute a likelihood ratio test statistic based on a ratio of the first likelihood to the second likelihood; and
cluster the two or more first tracklets into a first clustered tracklet of the one or more of first clustered tracklets based on the likelihood ratio test statistic and a likelihood ratio test threshold based on a first similarity criteria of the one or more similarity criteria.

6. The apparatus of claim 5, wherein to determine the first likelihood that each respective first tracklet of the two or more first tracklets together form the coherent tracklet, the one or more processors are configured to cause the apparatus to:
identify one or more common states among the respective sequence of states associated with each respective first tracklet of the two or more first tracklets;
assign a weight to each respective common state among the one or more common states associated with each respective first tracklet of the two or more first tracklets based on one or more factors; and
determine the first likelihood based on the weighted one or more common states.

7. The apparatus of claim 5, wherein to determine the second likelihood that each respective first tracklet of the two or more first tracklets together do not form the coherent tracklet, the one or more processors are configured to cause the apparatus to:
identify one or more common states among the respective sequence of states associated with each respective first tracklet of the two or more first tracklets;
assign a weight to each respective common state among the one or more common states associated with each respective first tracklet of the two or more first tracklets based on one or more factors; and
determine the second likelihood based on the weighted one or more common states.

8. The apparatus of claim 1, wherein:
to detect the one or more objects, the one or more processors are configured to cause the apparatus to detect the one or more objects as a plurality of first detections, each respective first detection of the plurality of first detections being associated with a respective object at a respective first timestamp within the first period of time; and
the one or more processors are configured to cause the apparatus to generate a graph comprising:
a plurality of first nodes representing the plurality of first detections; and
a plurality of first edges,
wherein each respective first node of the plurality of first nodes is associated with a respective first detection of the plurality of first detections, and
wherein each respective first edge connects two first nodes of the plurality of first nodes associated with a same first timestamp and associated with different first tracklets; and
to cluster the two or more first tracklets into the one or more first clustered tracklets, the one or more processors are configured to cause the apparatus to cluster the two or more first tracklets into the one or more first clustered tracklets based on the graph.

9. The apparatus of claim 8, wherein to generate the graph comprising the plurality of first nodes and the plurality of first edges, the one or more processors are configured to cause the apparatus to:
generate a respective first node for each respective first detection of the plurality of first detections to create the plurality of first nodes, wherein each respective first node represents one or more respective states associated with the respective first detection;
generate a respective second edge between each respective pair of first nodes associated with the same first timestamp and associated with the different first tracklets to create a plurality of second edges;
assign a respective weight to each respective second edge based on at least one respective state of the one or more respective states associated with each respective first node of the respective pair of first nodes; and
remove at least one second edge of the plurality of second edges based on the respective weight assigned to the at least one second edge,
wherein the plurality of first edges comprises the plurality of second edges after the removal.

10. The apparatus of claim 9, wherein to cluster the two or more first tracklets into the one or more first clustered tracklets, the one or more processors are configured to cause the apparatus to:
generate a respective hypothesis for each respective combination of first tracklets associated with first nodes connected via one or more second edges of the plurality of second edges to create a plurality of hypotheses, the respective hypothesis indicating a likelihood that the respective combination of first tracklets form a coherent tracklet; and
cluster the two or more first tracklets based on the plurality of hypotheses.

11. The apparatus of claim 9, wherein to assign the respective weight to each respective second edge, the one or more processors are configured to cause the apparatus to:
assign a first respective weight to each respective second edge based on the at least one respective state associated with each respective first node having a similarity that satisfies a threshold similarity; and
assign a second respective weight to each respective second edge based on the at least one respective state associated with each respective first node having the similarity that does not satisfy the threshold similarity, the first respective weight being greater than the second respective weight.

12. The apparatus of claim 8, wherein to generate the graph comprising the plurality of first nodes and the plurality of first edges, the one or more processors are configured to cause the apparatus to:
generate a respective first node for each respective first detection of the plurality of first detections to create the plurality of first nodes, wherein each respective first node represents one or more respective states associated with the respective first detection;
generate a respective second edge between each respective pair of first nodes associated with the same first timestamp and associated with the different first tracklets to create a plurality of second edges; and
remove at least one second edge of the plurality of second edges based on the respective pair of first nodes associated with the at least one second edge being associated with at least one of:
different objects among the one or more objects; or
locations that are a first distance apart, the first distance satisfying a distance threshold,
wherein the plurality of first edges comprises the plurality of second edges after the removal.

13. The apparatus of claim 12, wherein to cluster the two or more first tracklets into the one or more first clustered tracklets, the one or more processors are configured to cause the apparatus to:
generate a respective hypothesis for each respective combination of first tracklets associated with first nodes connected via one or more second edges of the plurality of second edges to create a plurality of hypotheses, the respective hypothesis indicating a likelihood that the respective combination of first tracklets form a coherent tracklet; and
cluster the two or more first tracklets based on the plurality of hypotheses.

14. The apparatus of claim 8, wherein:
the graph further comprises a plurality of second edges, wherein each respective second edge connects two first nodes of the plurality of first nodes associated with different first timestamps; and
to generate the plurality of first tracklets, the one or more processors are configured to cause the apparatus to generate the plurality of first tracklets based on the graph.

15. The apparatus of claim 14, wherein to generate the graph comprising the plurality of first nodes and the plurality of second edges, the one or more processors are configured to cause the apparatus to:
generate a respective first node for each respective first detection of the plurality of first detections to create the plurality of first nodes, wherein each respective first node represents one or more respective states associated with the respective first detection;
generate a respective third edge between each respective pair of first nodes associated with different first timestamps to create a plurality of third edges in the graph;
assign a respective weight to each respective third edge based on at least one respective state of the one or more respective states associated with each respective first node of the respective pair of first nodes; and
remove at least one third edge of the plurality of third edges based on the respective weight assigned to the at least one third edge,
wherein the plurality of second edges comprises the plurality of third edges after the removal.

16. The apparatus of claim 15, wherein to generate the plurality of first tracklets, the one or more processors are configured to cause the apparatus to:
generate a respective hypothesis for each respective pair of first nodes connected via a second edge of the plurality of second edges, each respective hypothesis indicating a likelihood that the respective pair of first nodes are associated; and
generate at least one first tracklet for at least one respective pair of first nodes based on the respective hypothesis associated with the respective pair of first nodes.

17. The apparatus of claim 8, wherein:
the first set of frames and the graph are associated with a first temporal resolution; and
the one or more processors are configured to cause the apparatus to adjust the graph to have a second temporal resolution that is smaller than or larger than the first temporal resolution.

18. The apparatus of claim 1, wherein to determine the second trajectory for the set of the one or more objects over the second period of time based on the first clustered tracklet, the one or more processors are configured to cause the apparatus to:
predict a regular motion of the set of the one or more objects based on one or more deterministic motion equations;
predict one or more probabilistic maneuvers of the set of the one or more objects; and
determine one or more future states associated with the set of the one or more objects based on the regular motion and the one or more probabilistic maneuvers.

19. The apparatus of claim 1, wherein each respective sequence of states associated with each respective object and each respective first tracklet comprises at least one of:
a size of the respective object;
a location of the respective object in a scene;
an orientation of the respective object;
a pose estimation of the respective object;
one or more shape descriptors associated with the respective object;
one or more visual features of the respective object;
a velocity of the respective object;
an acceleration of the respective object;
a heading of the respective object;
a semantic class associated with the respective object;
a semantic class confidence score;
a trajectory score associated with the respective object;
one or more confidence scores;
a trajectory standard deviation;
time elapsed since a last detection of the respective object;
one or more dynamics of the scene;
an occlusion state of the respective object;
one or more interaction features;
an environmental context;
an appearance change rate;
a measure of a consistency of the respective object;
a tracking history of the respective object;
a predicted future position of the respective object;
a sensor modality confidence score;
scene flow information; or
optical flow information.

20. A method for object tracking, comprising:
determining a respective plurality of states for one or more objects in a first set of frames associated with a first temporal resolution;
generating a plurality of association graphs, wherein:
each association graph represents a respective trajectory of, at least one of, a first object of the one or more objects or a first subset of objects of the one or more objects; and
each association graph is associated with a different temporal resolution based on adjusting the respective plurality of states for the one or more objects; and
tracking the one or more objects using the plurality of association graphs.
